(19) United States
(12) Patent Application Publication
(10) Pub. No.: US 2025/0088922 A1
(43) Pub. Date: Mar. 13, 2025

(54) CELL HANDOVER METHOD AND APPARATUS, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN); Jiangsheng FAN, Dongguan (CN)

(73) Assignee: GUANGDONG OPPO MOBILE TELECOMMUNICATIONS CORP., LTD., Dongguan (CN)

(21) Appl. No.: 18/958,344

(22) Filed: Nov. 25, 2024

Related U.S. Application Data
(63) Continuation of application No. PCT/CN2022/101613, filed on Jun. 27, 2022.

(51) Int. Cl. H04W 36/04; H04W 36/00

(52) U.S. Cl. CPC H04W 36/04; H04W 36/0061; H04W 36/00835

(57) ABSTRACT

Embodiments of this application provide a cell handover method and apparatus, a terminal device, a network device, a chip, a computer-readable storage medium, a computer program product, and a computer program. The method includes: receiving first signalling transmitted by a network device; performing handover to a target cell based on the first signalling, and determining corresponding processing of at least one protocol layer of a terminal device in a process of performing handover to the target cell.

### CROSS-REFERENCE TO RELATED APPLICATIONS

This application is a continuation of International Application No. PCT/CN2022/101613, filed on Jun. 27, 2022, the disclosure of which is hereby incorporated by reference in its entirety.

### TECHNICAL FIELD

Embodiments of this application relate to the field of mobile communications technologies, and specifically, to a cell handover method and apparatus, a terminal device, a network device, a chip, a computer-readable storage medium, a computer program product, and a computer program.

### RELATED ART

Similar to a long-term evolution (Long Term Evolution, LTE) system, a new radio access (NR Radio Access, NR) system supports a handover process of a user equipment (User Equipment, UE) in a connected state. When a UE that is using a network service moves from one cell to another cell, or when adjustment of a load of a wireless transmission service, activation operation and maintenance is performed or a device fault occurs, the system needs to transfer from a communications link between the UE and the original cell to a communications link between the UE and a new cell, that is, execute a handover process, to ensure continuity and quality of service of communication.

In a handover process in the prior art, if a UE may execute a plurality of times of handover according to a same set of candidate cell configurations in a specific area or within a period of time, a configuration relationship between a candidate cell and a current serving cell is changeable. A radio link control (Radio Link Control, RLC) configuration is used as an example. The RLC configuration is unnecessary to be changed when a UE moves from a cell 1 to a cell 2, and the RLC configuration needs to be changed when the UE moves from the cell 1 to a cell 3. In one case, the UE moves from the cell 1 to the cell 2 and then to the cell 3, RLC re-establishment needs to be executed once. In another case, the UE moves from the cell 1 to the cell 3 and then to the cell 2, RLC re-establishment needs to be executed twice.

### SUMMARY

Embodiments of this application provide a cell handover method and apparatus, a terminal device, a network device, a chip, a computer-readable storage medium, a computer program product, and a computer program.

An embodiment of this application provides a cell handover method, applied to a terminal device, where the method includes:
receiving first signalling transmitted by a network device, where the first signalling is used to indicate that a first candidate cell in at least one candidate cell is used as a target cell to which the terminal device is to be handed over, and the at least one candidate cell is used for layer 1 or layer 2 handover; and
handing over to the target cell based on the first signalling, and determining corresponding processing of at least one protocol layer of the terminal device in a process of handing over to the target cell.

An embodiment of this application provides a terminal device, where the terminal device includes a processor and a memory, the memory is configured to store a computer program, and the processor is configured to execute the computer program to cause the terminal device to perform a method including:
receiving first signalling transmitted by a network device, where the first signalling is used to indicate that a first candidate cell in at least one candidate cell is used as a target cell to which the terminal device is to be handed over, and the at least one candidate cell is used for layer 1 or layer 2 handover; and
handing over to the target cell based on the first signalling, and determining corresponding processing of at least one protocol layer of the terminal device in a process of handing over to the target cell.

An embodiment of this application provides a network device, where the network device includes a processor and a memory, the memory is configured to store a computer program, and the processor is configured to execute the computer program to cause the network device to perform a method including: transmitting first signalling to a terminal device, to instruct the terminal device to hand over to a target cell based on the first signalling, and determine corresponding processing of at least one protocol layer of the terminal device in a process of handing over to the target cell,
where the first signalling is used to indicate that a first candidate cell in at least one candidate cell is used as the target cell for to which the terminal device is to be handed over, and the at least one candidate cell is used for layer 1 or layer 2 handover.

### BRIEF DESCRIPTION OF DRAWINGS

The accompanying drawings described herein are used to provide a further understanding of this application, and constitute a part of this application. A schematic embodiment of this application and descriptions thereof are used to explain this application, and do not constitute an improper limitation of this application. In the accompanying drawings:

FIG. 1 is a schematic diagram of an application scenario according to an embodiment of this application.

FIG. 2 shows a cross-base station cell handover procedure according to an embodiment of this application.

FIG. 3 is a schematic structural diagram of an architecture of a 5G base station device according to an embodiment of this application.

FIG. 4 is a schematic structural diagram of an NG-RAN architecture according to an embodiment of this application.

FIG. 5 is a schematic diagram of a cell handover procedure under a CU-DU separation architecture according to an embodiment of this application.

FIG. 6 is a first schematic flowchart of a cell handover method according to an embodiment of this application.

FIG. 7 is a second schematic flowchart of a cell handover method according to an embodiment of this application.

FIG. 8 is a third schematic flowchart of a cell handover method according to an embodiment of this application.

FIG. 9 is a fourth schematic flowchart of a cell handover method according to an embodiment of this application.

FIG. 10 is a fifth schematic flowchart of a cell handover method according to an embodiment of this application.

FIG. 11 is a sixth schematic flowchart of a cell handover method according to an embodiment of this application.

FIG. 12 is a schematic structural diagram 1 of a cell handover apparatus according to an embodiment of this application.

FIG. 13 is a schematic structural diagram 2 of a cell handover apparatus according to an embodiment of this application.

FIG. 14 is a schematic structural diagram of a communications device according to an embodiment of this application.

FIG. 15 is a schematic structural diagram of a chip according to an embodiment of this application.

FIG. 16 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. All other embodiments obtained by persons of ordinary skill in the art based on embodiments of this application without creative efforts fall within the protection scope of this application.

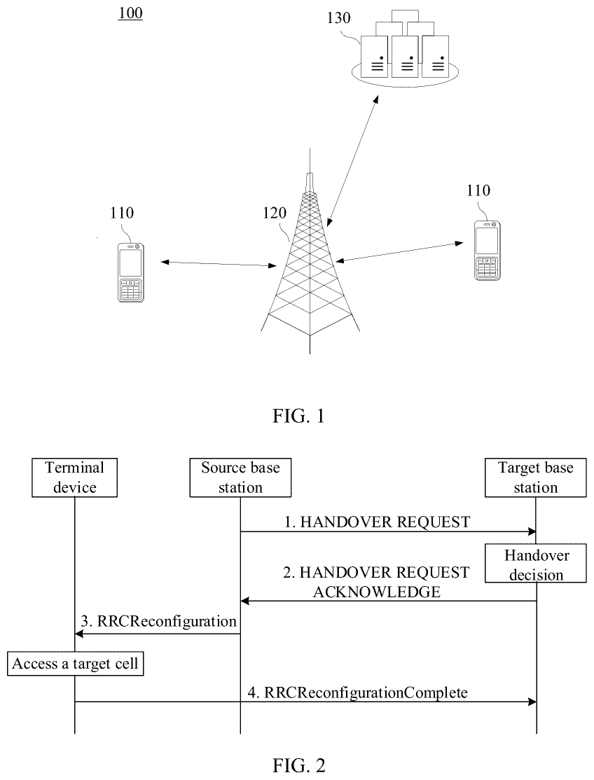

In a continuous cell handover process, if a configuration relationship between a candidate cell and a current serving cell changes, a terminal device cannot determine whether to execute RLC re-establishment. FIG. 1 is a schematic diagram of an application scenario according to an embodiment of this application. As shown in FIG. 1, a communications system 100 may include terminal devices 110 and a network device 120. The network device 120 may communicate with the terminal devices 110 by using air interfaces. Multi-service transmission may be performed between the terminal devices 110 and the network device 120.

It should be understood that the communications system 100 is merely used as an example for description in this embodiment of this application, but this embodiment of this application is not limited thereto. That is, the technical solutions in embodiments of this application may be applied to various communications systems, for example, a long-term evolution (LTE) system, LTE time division duplex (TDD), a universal mobile telecommunications system (UMTS), an internet of things (IIOT) system, a narrowband internet of things (NB-IoT) system, an enhanced machine-type communications (eMTC) system, a 5G communications system (also referred to as a new radio (NR) communications system), or a future communications system.

In the communications system 100 shown in FIG. 1, the network device 120 may be an access network device that communicates with the terminal devices 110. The access network device may provide communication coverage for a specific geographical area, and may communicate with a terminal device 110 (for example, a UE) located in the coverage area.

The network device 120 may be an evolved Node B (eNB or eNodeB) in a long-term evolution (LTE) system, or a next-generation radio access network (NG RAN) device, or a gNB (gNB) in an NR system, or a wireless controller in a cloud radio access network (CRAN). Alternatively, the network device 120 may be a relay station, an access point, a vehicle-mounted device, a wearable device, a hub, a switch, a bridge, a router, a network device in a future evolved public land mobile network (PLMN), or the like.

The terminal device 110 may be any terminal device, which includes but is not limited to a terminal device that is connected to the network device 120 or another terminal device by using a wired or wireless connection.

For example, the terminal device 110 may be an access terminal, a user equipment (UE), a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device with a wireless communication function, a computing device, another processing device connected to a wireless modem, a vehicle-mounted device, a wearable device, a terminal device in a 5G network, a terminal device in a future evolved network, or the like.

The terminal device 110 may be configured to perform device-to-device (D2D) communication.

The wireless communications system 100 may further include a core network device 130 that communicates with a base station. The core network device 130 may be a 5G core network (5GC) device, for example, an access and mobility management function (AMF), for another example, an authentication server function (AUSF), for another example, a user plane function (UPF), or for another example, a session management function (SMF). Optionally, the core network device 130 may also be an evolved packet core (EPC) device of an LTE network, for example, a session management function+core packet gateway (SMF+PGW-C) device. It should be understood that the SMF+PGW-C may implement both a function that can be implemented by an SMF and a function that can be implemented by a PGW-C. In a network evolution process, the foregoing core network device may also be called another name, or a new network entity may be formed by dividing a function of the core network, which is not limited in embodiments of this application.

Communication between functional units in the communications system 100 may be further implemented by establishing a connection by using a next-generation (NG) interface. For example, the terminal device establishes an air interface connection to an access network device by using an NR interface, to transmit user plane data and control plane signalling. The terminal device may establish a control plane signalling connection to an AMF by using an NG interface 1 (N1 for short). The access network device, for example, a next-generation radio access base station (gNB), may establish a user plane data connection to a UPF by using an NG interface 3 (N3 for short). The access network device may establish a control plane signalling connection to the AMF by using an NG interface 2 (N2 for short). The UPF may establish a control plane signalling connection to an SMF by using an NG interface 4 (N4 for short). The UPF may exchange user plane data with a data network by using an NG interface 6 (N6 for short). The AMF may establish a control plane signalling connection to the SMF by using an NG interface 11 (N11 for short). The SMF may establish a control plane signalling connection to a PCF by using an NG interface 7 (N7 for short).

FIG. 1 exemplarily shows one base station, one core network device, and two terminal devices. Optionally, the wireless communications system 100 may include a plurality of base station devices, and a coverage area of each base station may include another quantity of terminal devices. This is not limited in embodiments of this application.

It should be noted that FIG. 1 is merely an example of a system to which this application applies. Certainly, the methods shown in embodiments of this application may also be applied to another system. In addition, the terms “system” and “network” may often be used interchangeably herein. In this specification, the term “and/or” is merely an association that describes associated objects, and represents that there may be three relationships. For example, A and/or B may represent three cases: only A exists, both A and B exist, and only B exists. In addition, the character “/” herein generally indicates an “or” relationship between the associated objects. It should be further understood that, the “indication” mentioned in embodiments of this application may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association between A and B. It should be further understood that the term “corresponding” mentioned in embodiments of this application may mean that there is a direct or indirect correspondence between two elements, or that there is an association between two elements, or that there is a relationship of “indicating” and “being indicated”, “configuring” and “being configured”, or the like. It should be further understood that the “pre-defined” or “pre-defined rule” mentioned in embodiments of this application may be implemented in a manner in which corresponding code, a table, or other related information used for indication is pre-stored in a device (for example, including a terminal device and a network device). A specific implementation is not limited in this application. For example, pre-defining may refer to being defined in a protocol. It should be further understood that in embodiments of this application, the “protocol” may refer to a standard protocol in the communication field, for example, may include an LTE protocol, an NR protocol, and a related protocol applied to a future communications system. This is not limited in this application.

To facilitate understanding of the technical solutions in embodiments of this application, the following describes related technologies in embodiments of this application. The following related technologies may be randomly combined with the technical solutions in embodiments of this application as optional solutions, which all fall within the protection scope of embodiments of this application.

Similar to an LTE system, an NR system supports a handover process of a terminal device in a connected state. When a terminal device that is using a network service moves from one cell to another cell, or when adjustment of a load of a wireless transmission service, activation operation and maintenance is performed or a device fault occurs, the system needs to transfer from a communications link between the terminal device and the original cell to a communications link between the terminal device and a new cell, that is, execute a handover process, to ensure continuity and quality of service of communication.

FIG. 2 is a cross-base station cell handover procedure according to an embodiment of this application. As shown in FIG. 2, the cell handover procedure includes:
1. A source base station (Source gNB) triggers handover based on an L3 measurement result reported by a terminal device, and transmits a handover request (HANDOVER REQUEST) to a target cell under a target base station through an Xn interface;
2. The target base station (Target gNB) receives the handover request from the source base station, performs access control, provides a radio resource control (Radio Resource Control, RRC) configuration of the target cell, and feeds back the RRC configuration as a part of a handover request acknowledgement (HANDOVER REQUEST ACKNOWLEDGE) to the source base station;
3. The source base station transmits an RRC reconfiguration (RRCReconfiguration) to the terminal device, to instruct the terminal device to initiate a handover procedure, and to indicate RRC configuration information used to access the target cell; and
4. The terminal device accesses the target cell, and transmits an RRC reconfiguration complete (RRCReconfigurationComplete) to the target cell under the target base station.

After the terminal device receives a handover command (that is, RRC reconfiguration), a main behavior of each protocol layer (including a packet data convergence protocol (PDCP) layer, an RLC layer, and a medium access control (MAC) layer) includes:

| Operation of a | Handover requiring | Handover requiring no |
|---|---|---|
| protocol layer | secure updating | secure updating |
| PDCP layer | Re-establishment | PDCP data recovery |
| RLC layer | Re-establishment | Re-establishment |
| MAC layer | Resetting | Resetting |

1. Secure updating includes updating a key, an encryption algorithm, an integrity protection algorithm, or the like, which is definitely indicated in an RRCReconfiguration message. 2. PDCP layer re-establishment, PDCP data recovery, and RLC re-establishment of the terminal device are definitely indicated by the MAC layer in the RRCReconfiguration message. 3. The PDCP layer is mainly configured to perform encryption, decryption and integrity protection of an AS layer on data.

Further, a cell handover process under a CU-DU separation architecture is described below.

A base station main device mainly includes a BBU (Base Band Unit) and an AAU (Active Antenna Unit). The BBU is mainly configured to process a baseband signal, and the AAU is mainly configured to convert a baseband digital signal into an analog signal, modulate the analog signal into a high-frequency radio frequency signal, amplify power of the signal by using a power amplifier unit, and finally emit the signal by using an antenna.

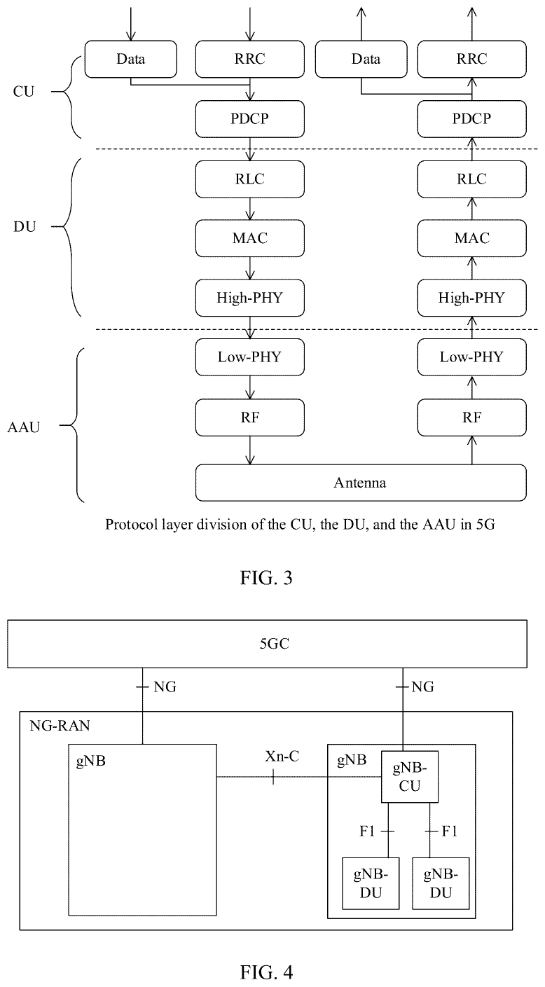

FIG. 3 is a schematic structural diagram of an architecture of a 5G base station device according to an embodiment of this application. As shown in FIG. 3, to enhance information exchange between sites and implement coordinated communication, a CU-DU separation architecture is introduced into the 5G base station. The full name of CU is centralized unit, and the full name of DU is distributed unit. A CU and a DU are classified according to real-time performance requirements of different protocol layers. Under this principle, a low physical layer in an original BBU is moved downstream into an AAU for processing, a high physical layer, a MAC layer, and an RLC layer with high requirements on real-time performance are placed in the DU for processing, and a PDCP layer and an RRC layer with low requirements on real-time performance are placed in the CU for processing. That is, the DU is configured to realize functions that are independent and have high requirements on real-time performance, while the CU is configured to realize functions that require information aggregation and have low requirements on real-time performance. The CU-DU separation architecture is beneficial to implement baseband resource sharing and radio access slicing and cloudification, and implments site coordination in a case of complex 5G networking.

FIG. 4 is a schematic structural diagram of an NG-RAN architecture according to an embodiment of this application. As shown in FIG. 4, a 5G radio access network (NG-RAN) includes a plurality of gNBs connected to a 5G core network (5GC). The gNBs are connected to the 5GC by using NG interfaces, and the gNBs are connected with each other by using an Xn interface. One gNB includes one gNB-CU and one or more gNB-DUs, and one gNB-CU may be connected to one or more gNB-DUs, but one gNB-DU can be connected to only one gNB-CU. The gNB-CU and the gNB-DU exchange data or signalling by using an F1 interface.

Under the CU-DU separation architecture, cell handover is further classified into the following two types.

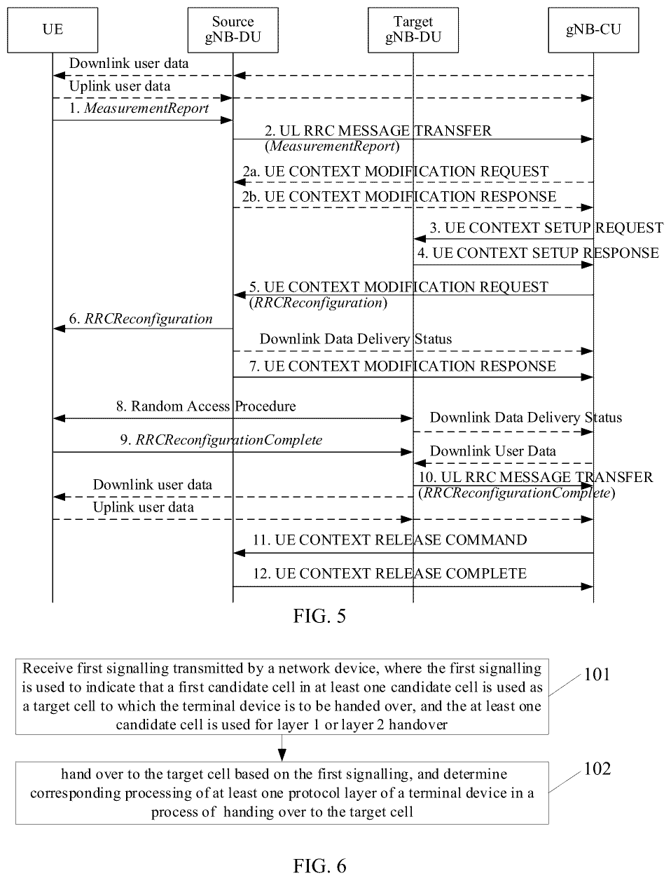

Cell handover in an intra-CU-inter-DU range, where intra-CU-inter-DU may be understood as: a source cell and a target cell belong to a same CU and different DUs. FIG. 5 is a schematic diagram of a cell handover procedure under a CU-DU separation architecture according to an embodiment of this application. As shown in FIG. 5, the cell handover procedure includes:
1. A UE reports an L3 measurement result (MeasurementReport) to a network, and the L3 measurement result is processed by a source gNB-DU (Source gNB-DU) and then delivered to a gNB-CU; the UE first establishes a connection to the gNB-CU by using the source gNB-DU, receives downlink user data (Downlink user data) transmitted by the gNB-CU, and transmits uplink user data (Uplink user data) to the gNB-CU; the source gNB-DU transmits a UL RRC MESSAGE TRANSFER to the gNB-CU, where the UL RRC MESSAGE TRANSFER carries a MeasurementReport message;
2. The gNB-CU executes a handover decision, to determine a target cell (the target cell and a source cell belong to different gNB-DUs);
3. The gNB-CU migrates underlying context of the UE from the source gNB-DU to a target gNB-DU, that is, performing step 3 and step 4 in FIG. 5, and establishes context on the target gNB-DU; the gNB-CU transmits a UE CONTEXT SETUP REQUEST message to the target gNB-DU, to create context of the UE and establish one or more data bearers; the target gNB-DU transmits a UE CONTEXT SETUP RESPONSE to the gNB-CU; the gNB-CU transmits a UE CONTEXT MODIFICATION REQUEST message to the source gNB-DU, where the UE CONTEXT MODIFICATION REQUEST message carries an RRCReconfiguration message, and instructs to stop data transmission of the UE; the source gNB-DU transmits Downlink Data Delivery Status frame information to the gNB-CU, to notify the gNB-CU of downlink data information of the UE that is not transmitted; and
4. The gNB-CU generates a handover instruction (RRCReconfiguration), and transmits the handover instruction to the UE by using the source gNB-DU, and the UE interacts with the target gNB-DU, to access the target cell. The source gNB-DU forwards the RRCReconfiguration message to the UE, and the source gNB-DU transmits a UE CONTEXT MODIFICATION RESPONSE message to the gNB-CU. The UE initiates a random access procedure to the target gNB-DU, and the UE transmits an RRCReconfigurationComplete message to the target gNB-DU. The target gNB-DU transmits a UL RRC MESSAGE TRANSFER message to the gNB-CU, where the UL RRC MESSAGE TRANSFER message carries an RRCReconfigurationComplete message. In this case, uplink data and downlink data start to be transmitted. The gNB-CU transmits a UE CONTEXT RELEASE COMMAND to the source gNB-DU, and the source gNB-DU releases the context of the UE and returns a UE CONTEXT RELEASE COMPLETE message to the gNB-CU.

Cell handover in an intra-CU-intra-DU range, where intra-CU-intra-DU may be understood as: a source cell and a target cell belong to a same CU and a same DU. A cell handover procedure includes:
1. A UE reports an L3 measurement result (MeasurementReport) to a network, and the L3 measurement result is processed by a source gNB-DU (Source gNB-DU) and then delivered to a gNB-CU;
2. The gNB-CU executes a handover decision, to determine a target cell (the target cell and a source cell belong to a same gNB-DU);
3. The gNB-CU executes a UE context modification (context modification) procedure, that is, in step 2a of FIG. 5, the gNB-CU transmits a UE CONTEXT MODIFICATION REQUEST message to the source gNB-DU, and in step 2b, the source gNB-DU returns a UE CONTEXT MODIFICATION RESPONSE message, to update underlying context of the UE in the source gNB-DU, for example, a tunnel endpoint identifier (TEID) in an upstream or downstream GPRS tunneling protocol (GTP); and
4. The gNB-CU generates a handover instruction (RRCReconfiguration), and transmits the handover instruction to the UE by using the source gNB-DU; the UE interacts with the source gNB-DU to access the target cell.

For the foregoing cell handover method, if a UE may execute a plurality of times of handover according to a same set of candidate cell configurations in a specific area or within a period of time, a configuration relationship between a candidate cell and a current serving cell is changeable. A radio link control (RLC) configuration is used as an example. The RLC configuration is unnecessary to be changed when a UE moves from a cell 1 to a cell 2, and the RLC configuration needs to be changed when the UE moves from the cell 1 to a cell 3. In one case, the UE moves from the cell 1 to the cell 2 and then to the cell 3, RLC re-establishment needs to be executed once. In another case, the UE moves from the cell 1 to the cell 3 and then to the cell 2, RLC re-establishment needs to be executed twice. Therefore, in a continuous L1 or L2 handover process, RLC re-establishment of a terminal device cannot be included in configuration information of a candidate cell through pre-configuration.

An embodiment of this application provides a cell handover method. If a UE may execute a plurality of times of handover according to a same set of candidate cell configurations in a specific area or within a period of time, a network device triggers, by delivering first signalling, a terminal device to perform cell handover, and determines, based on the first signalling, corresponding processing of at least one protocol layer of the terminal device in a handover process, thereby resolving a problem that corresponding processing of at least one protocol layer changes with changing of a source cell when a candidate cell is used as a target cell, in a plurality of handover processes.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

An embodiment of this application further provides a cell handover method, applied to a terminal device. FIG. 6 is a first schematic flowchart of the cell handover method in this embodiment of this application. As shown in FIG. 6, the cell handover method includes steps 101 and 102.

In step 101, first signalling transmitted by a network device is received, where the first signalling is used to indicate that a first candidate cell in at least one candidate cell is used as a target cell to which the terminal device is to be handed over, and the at least one candidate cell is used for layer 1 or layer 2 handover.

Herein, the first signalling is used to trigger the terminal device to execute cell handover. Exemplarily, the first signalling is layer 1 (L1) signalling and/or layer 2 (L2) signalling. When cell handover is triggered by using layer 1 signalling and/or layer 2 signalling, the terminal device executes cell handover processing by using a layer 1 and/or a layer 2, which can reduce a latency in protocol stack processing and therefore reduce a cell handover latency. In a handover process triggered by L3 signalling (RRCReconfiguration), after the terminal device receives the L3 signalling, corresponding processing of each protocol layer needs to be performed in a process of handing over to the target cell, and a latency in protocol stack processing is relatively large, resulting in a relatively large handover latency. Therefore, compared with cell handover triggered by using L3 signalling, cell handover triggered by using layer 1 signalling and/or layer 2 signalling can reduce a latency in protocol stack processing and therefore reduce a cell handover latency.

Herein, the at least one candidate cell is one or more candidate cells configured by the network device within a period of time or in a specific area. The terminal device determines the target cell in a same set of candidate cells within the period of time or in the specific area, and performs a plurality of times of cell handover.

In some embodiments, before the first signalling transmitted by the network device is received, the method further includes: receiving first configuration information transmitted by the network device, where the first configuration information includes configuration information of the at least one candidate cell.

It may be understood that before delivering the first signalling to trigger cell handover, the network device first needs to transmit the first configuration information, where the first configuration information is used to configure a set of candidate cells for the terminal device, and the terminal device executes a plurality of times of handover according to a same set of candidate cell configurations in a specific area or within a period of time. Exemplarily, configuration information of each candidate cell includes at least one of the following: (a) an index of the candidate cell; (b) a measurement configuration of the candidate cell; or (c) configuration information dedicated to the candidate cell and/or configuration information dedicated to the terminal device. Exemplarily, the configuration information includes a cell identity (Cell Identity), a cell radio network temporary identifier (C-RNTI), system information of the cell, a timing advance group identity (TAG ID), an uplink bandwidth, a downlink bandwidth configuration, an RLC layer configuration, a MAC layer configuration, a PHY layer configuration, and the like. Exemplarily, the first configuration information may be carried by an RRC message. In actual application, the at least one candidate cell configured by using the first configuration information includes or does not include a current serving cell.

In some embodiments, after the first configuration information transmitted by the network device is received, the method further includes: measuring, by the terminal device, all or some of candidate cells to obtain a cell measurement result, and reporting the cell measurement result to the network device, so that the network device executes a measurement decision according to the cell measurement result to determine the target cell, generates the first signalling, and delivers the first signalling to the terminal device to trigger cell handover. Exemplarily, the terminal device measures a downlink reference signal of all or some of the candidate cells, to obtain a measurement result at a beam or cell level. The downlink reference signal includes a synchronization signal block (SSB) and a channel state indicator reference signal (CSI-RS).

Further, the terminal device receives the first signalling transmitted by the network device, and is handed over to the target cell based on the first signalling. The first signalling is used to indicate that the first candidate cell in the at least one candidate cell is used as the target cell to which the terminal device is to be handed over. In addition, the first signalling may further indicate or activate a transmission configuration indication (TCI) state for the target cell, and provide the terminal device with information about a beam that works in the target cell.

In step 102, the terminal device is handed over to the target cell based on the first signalling, and corresponding processing of at least one protocol layer of the terminal device in a process of handing over to the target cell is determined.

Herein, the at least one protocol layer is a protocol layer in the layer 2, and includes an RLC layer, a PDCP layer, and a MAC layer. Correspondingly, the corresponding processing of the protocol layer includes at least one of the following: RLC re-establishment (Re-establish), PDCP data recovery (Data recovery), MAC resetting (Reset), MAC partial resetting (Partial reset), MAC no resetting, or PDCP layer re-establishment. Exemplarily, MAC partial resetting includes at least one of the following: clearing a hybrid automatic repeat request (HARQ) buffer, canceling triggered beam failure recovery (BFR), or canceling a triggered scheduling request (SR).

In this embodiment of this application, the corresponding processing of the at least one protocol layer may be indicated by the first signalling, may be pre-configured by the network device for each candidate cell, or may be pre-defined in a protocol.

In some embodiments, the first signalling includes first indication information, and the first indication information is used to indicate the corresponding processing of the at least one protocol layer. The first signalling is layer 1 signalling and/or layer 2 signalling, that is, the network device carries information about cell handover by using layer 1 signalling and/or layer 2 signalling, and transmits the information to the terminal device, to trigger the terminal device to execute cell handover, and to indicate the corresponding processing of the at least one protocol layer.

It may be understood that, in one case, the first indication information may be used to indicate whether the terminal device executes the corresponding processing of the at least one protocol layer. In another case, when the first indication information indicates the corresponding processing of the at least one protocol layer that is to be executed, it may be understood that the first indication information is used to indicate one or more specific operations in the corresponding processing of the at least one protocol layer that is to be executed. When the first indication information indicates that the corresponding processing of the at least one protocol layer is not to be executed, it may be understood that the corresponding processing of the at least one protocol layer that is indicated by the first indication information is empty. That is, the first indication information may include information indicating that the corresponding processing of the at least one protocol layer is to be executed or not to be executed, or may include an index of the corresponding processing of the at least one protocol layer, or may include an index of one or more operations in the corresponding processing of the at least one protocol layer. The first indication information may be any type of indication information, for example, an indication bit or an index of corresponding processing of a protocol layer.

Exemplarily, the corresponding processing of the at least one protocol layer includes RLC re-establishment, PDCP data recovery, and MAC resetting. The first indication information is used to instruct to execute RLC re-establishment, PDCP data recovery, and MAC resetting in the process of handing over to the target cell, or is used to instruct not to execute RLC re-establishment, PDCP data recovery, and MAC resetting.

Exemplarily, the first indication information includes a first indication field, and the first indication field is used to indicate the corresponding processing of the at least one protocol layer. Exemplarily, the first indication field may include one or more indication bits. A quantity of bits occupied by the first indication field is not specifically limited in embodiments of this application. In an implementation in which the first indication field includes two or more indication bits, a location relationship between the indication bits is not limited.

In some embodiments, the first indication field includes at least two indication bits, and the at least two indication bits are used to indicate the corresponding processing of the at least one protocol layer. Exemplarily, an indication manner of an indication bit includes at least one of the following: one indication bit is used to indicate corresponding processing of one protocol layer of the terminal device, one indication bit is used to indicate corresponding processing of a plurality of protocol layers of the terminal device, two or more indication bits are used to indicate corresponding processing of one protocol layer of the terminal device, or two or more indication bits are used to indicate corresponding processing of a plurality of protocol layers of the terminal device.

When the first indication field includes two or more indication bits, the first indication field can carry more information, to more flexibly indicate the corresponding processing of the at least one protocol layer. That is, when an optional range of the corresponding processing of the at least one protocol layer includes corresponding processing of more than two protocol layers, for example, the first type is to execute RLC re-establishment, the second type is to execute PDCP data recovery, the third type is to execute RLC re-establishment and PDCP data recovery, and the fourth type is to execute RLC re-establishment, PDCP data recovery, MAC resetting, and the like. Each indication bit may be used to indicate one or more operations, or at least two indication bits form an entity to indicate the corresponding processing of the at least one protocol layer.

In some embodiments, the process of determining corresponding processing of at least one protocol layer of the terminal device in a process of handing over to the target cell includes: determining, based on pre-defined information, the corresponding processing of the at least one protocol layer that is to be executed by the terminal device in the process of handing over to the target cell. The pre-defined information may be corresponding processing of at least one protocol layer that is to be executed by the terminal device by default during execution of cell handover and that is pre-defined in a protocol. For example, RLC re-establishment, PDCP data recovery, and MAC resetting are to be executed by default.

In some embodiments, corresponding processing of protocol layers may be all pre-defined in a protocol. Alternatively, corresponding processing of some of the protocol layers is pre-defined in a protocol, and corresponding processing of the other protocol layers is indicated by the first indication information. For example, RLC re-establishment and PDCP data recovery are indicated by the first indication information, while MAC resetting, MAC partial resetting, and MAC no resetting are pre-defined in a protocol.

In some embodiments, the method further includes: determining, based on the first indication information, that the terminal device executes PDCP data recovery and triggers a PDCP status report in the process of handing over to the target cell. Specifically, when an upper layer requests re-establishment of a PDCP entity or the upper layer requests PDCP data recovery, the PDCP status report is triggered and the PDCP status report is transmitted on an uplink.

Exemplarily, in some embodiments, the first signalling includes second indication information, and the second indication information is used to indicate that the first candidate cell in the at least one candidate cell is used as the target cell to which the terminal device is to be handed over. Exemplarily, the second indication information is identity information of the target cell, that is, identity information of the first candidate cell, and is used to indicate that the first candidate cell is used as the target cell. Exemplarily, the identity information of the target cell may be an index of the target cell, an ID of the target cell, an indication bit of the target cell, or the like. The target cell may be a special cell (SpCell) and/or a secondary cell (SCell).

Exemplarily, the first signalling includes the first indication information and the second indication information, the first indication information is used to indicate the corresponding processing of the at least one protocol layer, and the second indication information is used to indicate the target cell. Alternatively, the first signalling includes the second indication information, the second indication information is used to indicate the target cell, and the corresponding processing of the at least one protocol layer may be pre-defined in a protocol.

Exemplarily, in some embodiments, the first signalling is carried by a medium access control control element (MAC CE) and/or downlink control information (DCI).

The following provides four choices by way of example, to further describe an indication manner of the first indication field by using examples.

Choice 1: The first indication field is used to indicate RLC re-establishment and PDCP data recovery of the terminal device.

When the first indication field includes one indication bit, the first indication field is set to 1, the terminal device executes RLC re-establishment and PDCP data recovery procedures; or when the first indication field is set to 0, the terminal device does not execute RLC re-establishment and PDCP data recovery procedures. In addition, a behavior of the terminal device further includes at least one of the following:
Option 1: MAC resetting is performed;
Option 2: If the first indication field is set to 1, MAC resetting is performed; or if the first indication field is set to 0, MAC resetting is not performed; or
Option 3: If the first indication field is set to 1, MAC resetting is performed; or if the first indication field is set to 0, MAC partial resetting is performed.

Choice 2: The first indication field is used to indicate RLC re-establishment, PDCP data recovery, and MAC resetting of the terminal device. When the first indication field is set to 1, the terminal device executes RLC re-establishment, PDCP data recovery, and MAC resetting procedures; or when the first indication field is set to 0, the terminal device does not perform RLC re-establishment and PDCP data recovery. For the MAC layer, a behavior of the terminal device includes at least one of the following:
Option 1: MAC resetting is not performed; or
Option 2: MAC partial resetting is performed.

Choice 3: The first indication field includes two indication bits, where a first indication bit is used to indicate RLC re-establishment and PDCP data recovery of the terminal device, and a second indication bit is used to indicate MAC resetting of the terminal device.

In one implementation, different indication bits separately perform indication without affecting each other. Exemplarily, when the first indication field is set to 11, the terminal device executes RLC re-establishment, PDCP data recovery, and MAC resetting. When the first indication field is set to 10, the terminal device executes RLC re-establishment and PDCP data recovery, and does not execute MAC resetting.

In another implementation, a resetting operation indicated by one indication bit is affected by another indication bit. Exemplarily, when the first indication field is set to 11 or 10, the terminal device executes RLC re-establishment, PDCP data recovery, and MAC resetting. That is, if the first indication bit is set to 1, MAC resetting needs to be performed regardless of a value assigned to the second indication bit.

When the first indication field is set to 01, the terminal device executes MAC resetting.

When the first indication field is set to 00, the terminal device does not execute MAC resetting or executes MAC partial resetting.

For the choice 3, in another implementation, the second indication bit is used to indicate one of MAC resetting, MAC no resetting, or MAC partial resetting. For example, the second indication bit is extended to two bits, where 11 indicates MAC resetting, 10 indicates MAC partial resetting, and 00 indicates MAC no resetting. That is, a quantity of bits occupied by the first indication field is not specifically limited in embodiments of this application.

Choice 4: Two indication bits form an entity, which is used to indicate the corresponding processing of the at least one protocol layer of the terminal device, as shown in Table 1.

TABLE 1

| | | | | First |
|---|---|---|---|---|
| | PDCP | RLC | MAC | indication field |
| Option 1 | Data | Re-establishment | Resetting | 11 |
| | recovery | | | |
| Option 2 | — | — | Resetting | 01 |
| Option 3 | — | — | Partial | 10 |
| | | | resetting | |
| Option 4 | — | — | — | 00 |

MAC partial resetting in the foregoing choices 1 to 4 may be specifically pre-defined in a protocol, or behaviors included in MAC partial resetting may be further indicated by the first indication field, for example, clearing transport data blocks in uplink or downlink HARQ buffers, canceling triggered BFR, and canceling a triggered SR.

Exemplarily, when the first indication information indicates RLC re-establishment and PDCP data recovery, after the terminal device receives the first indication information, a behavior of the terminal device includes:
Option 1: The MAC layer instructs the RLC layer and the PDCP layer to execute a corresponding procedure; or
Option 2: The MAC layer indicates RRC, and the RRC further instructs the RLC layer and the PDCP layer to execute a corresponding procedure.

By using the foregoing technical solution, when a plurality of times of cell handover is executed according to a same set of candidate cell configurations, a network device triggers, by delivering first signalling (layer 1 signalling or layer 2 signalling), a terminal device to perform cell handover, and determines, based on the first signalling, corresponding processing of at least one protocol layer of the terminal device in a handover process, thereby resolving a problem that corresponding processing of at least one protocol layer changes with changing of a source cell when a candidate cell is used as a target cell, in a plurality of handover processes, implementing accurate configurations of the corresponding processing of the at least one protocol layer, and thus reducing a handover latency. In addition, compared with cell handover triggered by using layer 3 signalling, cell handover triggered by using layer 1 signalling and/or layer 2 signalling can reduce a latency in protocol stack processing and therefore reduce a cell handover latency.

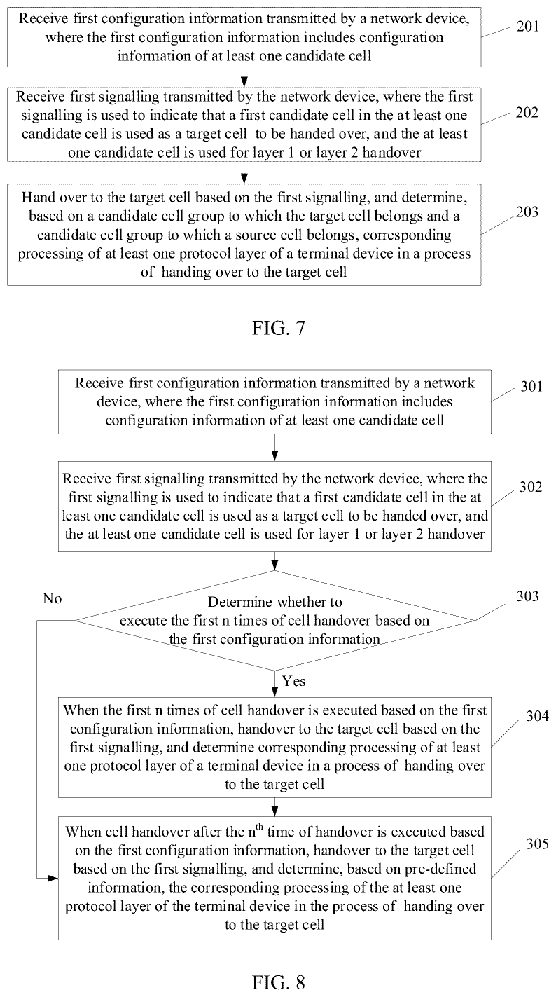

FIG. 7 is a second schematic flowchart of a cell handover method according to an embodiment of this application. As shown in FIG. 7, when at least one candidate cell is grouped into at least one candidate cell group, and each candidate cell group includes at least one candidate cell, the cell handover method includes steps 201 to 203.

In step 201, first configuration information transmitted by a network device is received, where the first configuration information includes configuration information of the at least one candidate cell.

Herein, the first configuration information further includes configuration information of the at least one candidate cell group, and configuration information of each candidate cell group includes configuration information of at least one candidate cell. The at least one candidate cell is grouped into the at least one candidate cell group by using the first configuration information, and a terminal device determines, based on a candidate cell group to which a target cell belongs and a candidate cell group to which a source cell belongs, corresponding processing of at least one protocol layer of the terminal device in a process of handing over to the target cell. Exemplarily, the first configuration information is carried by an RRC message.

It may be understood that before delivering first signalling to trigger cell handover, the network device first needs to transmit the first configuration information, where the first configuration information is used to configure a set of candidate cells for the terminal device, and the terminal device executes a plurality of times of handover according to a same set of candidate cell configurations in a specific area or within a period of time. Exemplarily, configuration information of each candidate cell includes at least one of the following: (a) an index of the candidate cell; (b) a measurement configuration of the candidate cell; or (c) configuration information dedicated to the candidate cell and/or configuration information dedicated to the terminal device. Exemplarily, the configuration information includes a cell identity, a C-RNTI of the cell, system information of the cell, a TAG ID, an uplink bandwidth, a downlink bandwidth configuration, an RLC layer configuration, a MAC layer configuration, a PHY layer configuration, and the like. Exemplarily, the first configuration information may be carried by an RRC message. In actual application, the at least one candidate cell configured by using the first configuration information includes or does not include a current serving cell.

In some embodiments, after the first configuration information transmitted by the network device is received, the method further includes: measuring, by the terminal device, all or some of candidate cells to obtain a cell measurement result, and reporting the cell measurement result to the network device, so that the network device executes a measurement decision according to the cell measurement result to determine the target cell, generates the first signalling, and delivers the first signalling to the terminal device to trigger cell handover. Exemplarily, the terminal device measures a downlink reference signal (an SSB or a CSI-RS) of all or some of the candidate cells, to obtain a measurement result at a beam or cell level.

In step 202, the first signalling transmitted by the network device is received, where the first signalling is used to indicate that a first candidate cell in the at least one candidate cell is used as the target cell to which the terminal device is to be handed over, and the at least one candidate cell is used for layer 1 or layer 2 handover.

The first signalling is used to indicate that the first candidate cell in the at least one candidate cell is used as the target cell to which the terminal device is to be handed over. Exemplarily, the first signalling includes first indication information, and the first indication information is used to indicate that the first candidate cell is used as the target cell. The first indication information may be an index of the target cell, an ID of the target cell, an indication bit of the target cell, or the like.

Exemplarily, the first indication information includes an index of a candidate cell group to which the first candidate cell belongs and/or an index of the first candidate cell. That is, the first indication information indicates the corresponding processing of the at least one protocol layer by indicating the candidate cell group to which the first candidate cell belongs.

It may be understood that, candidate cells are grouped into groups, grouping configuration is performed on corresponding processing of protocol layers according to the candidate cell groups, and the corresponding processing of the at least one protocol layer is determined based on the candidate cell group to which the target cell belongs and the candidate cell group to which the source cell belongs.

In some embodiments, the first indication information may be further used to indicate the corresponding processing of the at least one protocol layer. It may be understood that corresponding processing of protocol layers of a layer 2 may be all pre-configured by grouping the candidate cells into groups, or corresponding processing of some of the protocol layers is pre-configured by grouping the candidate cells into groups, and corresponding processing of the other protocol layers is indicated by the first indication information. For example, RLC re-establishment and PDCP data recovery are pre-configured by grouping the candidate cells into groups, while MAC resetting, MAC partial resetting, and MAC no resetting are indicated by the first indication information.

Exemplarily, the first indication information may include first sub-indication information and second sub-indication information, where the first sub-indication information is used to indicate the index of the candidate cell group to which the first candidate cell belongs and/or the index of the first candidate cell, and the second sub-indication information is used to indicate the corresponding processing of the at least one protocol layer of the terminal device.

In step 203, the terminal device is handed over to the target cell based on the first signalling, and based on the candidate cell group to which the target cell belongs and the candidate cell group to which the source cell belongs, the corresponding processing of the at least one protocol layer of the terminal device in the process of handing over to the target cell is determined.

In some embodiments, the process of determining, based on the candidate cell group to which the target cell belongs and the candidate cell group to which the source cell belongs, the corresponding processing of the at least one protocol layer of the terminal device in the process of handing over to the target cell includes: determining that the target cell and the source cell belong to a first candidate cell group, and determining corresponding processing of at least one protocol layer corresponding to the first candidate cell group; or determining that the target cell belongs to a second candidate cell group, determining that the source cell belongs to a third candidate cell group, and determining the corresponding processing of the at least one protocol layer based on the second candidate cell group and the third candidate cell group. Exemplarily, corresponding processing of a same protocol layer or different protocol layers may be configured for different candidate cell groups. When the target cell and the source cell belong to a same candidate cell group, corresponding processing of a protocol layer corresponding to the candidate cell group is obtained; or when the target cell and the source cell do not belong to a same candidate cell group, the corresponding processing of the at least one protocol layer is determined based on the candidate cell group to which the target cell belongs, the candidate cell group to which the source cell belongs, and a cell handover principle between the candidate cell groups.

Exemplarily, the corresponding processing of the protocol layer corresponding to the first candidate cell group includes not executing RLC re-establishment and PDCP data recovery, corresponding processing of a protocol layer corresponding to the second candidate cell group includes executing RLC re-establishment and PDCP data recovery, and corresponding processing of a protocol layer corresponding to the third candidate cell group includes executing RLC re-establishment, PDCP data recovery, and MAC resetting.

Exemplarily, the cell handover rule between the candidate cell groups includes: when it is handed over from the first candidate cell group to the second candidate cell group, corresponding processing of a respective protocol layer includes executing RLC re-establishment; when it is handed over from the second candidate cell group to the third candidate group, corresponding processing of a respective protocol layer includes executing RLC re-establishment, PDCP data recovery, and MAC resetting.

In some embodiments, the process of determining, based on the candidate cell group to which the target cell belongs and the candidate cell group to which the source cell belongs, the corresponding processing of the at least one protocol layer of the terminal device in the process of handing over to the target cell includes: if the target cell and the source cell do not belong to a same candidate cell group, determining to execute the corresponding processing of the at least one protocol layer; or if the target cell and the source cell belong to a same candidate cell group, determining not to execute the corresponding processing of the at least one protocol layer. That is, in an implementation, the corresponding processing of the at least one protocol layer is pre-configured. When the target cell and the source cell do not belong to a same candidate cell group, it is determined to execute the corresponding processing of the at least one protocol layer; or when the target cell and the source cell belong to a same candidate cell group, it is determined not to execute the corresponding processing of the at least one protocol layer.

Exemplarily, grouping of the candidate cell groups is shown in Table 2, where the first indication information includes the index of the candidate cell group to which the first candidate cell belongs and/or the index of the first candidate cell.

TABLE 2

| Index of a candidate | Index of a | |
|---|---|---|
| cell group | candidate cell | Configuration of a candidate cell |
| Group#1 | Cell#1 | Configuration information 1 |
| | Cell#2 | Configuration information 2 |
| | Cell#3 | Configuration information 3 |
| | Cell#4 | Configuration information 4 |
| Group#2 | Cell#5 | Configuration information 5 |
| | Cell#6 | Configuration information 6 |
| | Cell#7 | Configuration information 7 |
| | Cell#8 | Configuration information 8 |
| Group#3 | Cell#9 | Configuration information 9 |

The terminal device determines, based on the first indication information, whether the target cell and the source cell belong to a same candidate cell group. Depending on a result of the determining, a behavior of the terminal device includes:
Option 1: If the target cell and the source cell do not belong to a same candidate cell group, PDCP data recovery, RLC re-establishment, and MAC resetting procedures are executed; or
Option 2: If the target cell and the source cell belong to a same candidate cell group, PDCP data recovery, RLC re-establishment, and MAC resetting are not executed, or one of MAC resetting, MAC partial resetting, or MAC no resetting is executed, which may be specifically pre-defined in a protocol or indicated by the first indication information.

In some embodiments, the process of determining the corresponding processing of the at least one protocol layer of the terminal device in the process of handing over to the target cell includes: determining, based on the at least one candidate cell group, that the terminal device does not execute RLC re-establishment, PDCP data recovery, and MAC resetting in the process of handing over to the target cell, and determining, based on the first signalling, MAC resetting, MAC partial resetting, or MAC no resetting of the terminal device. Exemplarily, MAC resetting, MAC partial resetting, or MAC no resetting of the terminal device is determined based on the first indication information in the first signalling. Further, the first indication information may also specifically indicate which part of MAC resetting is to be executed.

By using the foregoing technical solution, when a plurality of times of cell handover is executed according to a same set of candidate cell configurations, a network device pre-configures corresponding processing of one or more types of protocol layers by grouping candidate cells into groups, triggers, by delivering first signalling, a terminal device to perform cell handover, and determines, based on the first signalling, corresponding processing of at least one protocol layer of the terminal device in a handover process, thereby resolving a problem that corresponding processing of at least one protocol layer changes with changing of a source cell when a candidate cell is used as a target cell, in a plurality of handover processes, implementing accurate configurations of the corresponding processing of the at least one protocol layer, and thus reducing a handover latency. In addition, compared with cell handover triggered by using layer 3 signalling, cell handover triggered by using layer 1 signalling and/or layer 2 signalling can reduce a latency in protocol stack processing and therefore reduce a cell handover latency.

FIG. 8 is a third schematic flowchart of a cell handover method according to an embodiment of this application. As shown in FIG. 8, the cell handover method includes steps 301 to 305.

In step 301, first configuration information transmitted by a network device is received, where the first configuration information includes configuration information of at least one candidate cell.

The first configuration information is used to configure a set of candidate cells for a terminal device, and the terminal device executes a plurality of times of handover according to a same set of candidate cell configurations in a specific area or within a period of time.

In some embodiments, the first configuration information further includes configuration information of at least one candidate cell group, and configuration information of each candidate cell group includes configuration information of at least one candidate cell. The at least one candidate cell is grouped into the at least one candidate cell group by using the first configuration information, and the terminal device determines, based on a candidate cell group to which a target cell belongs and a candidate cell group to which a source cell belongs, corresponding processing of at least one protocol layer of the terminal device. Exemplarily, the first configuration information is carried by an RRC message.

In step 302, first signalling transmitted by the network device is received, where the first signalling is used to indicate that a first candidate cell in the at least one candidate cell is used as the target cell to which the terminal device is to be handed over, and the at least one candidate cell is used for layer 1 or layer 2 handover.

Herein, the first signalling is used to trigger the terminal device to execute cell handover, and the first signalling is used to indicate that the first candidate cell in the at least one candidate cell is used as the target cell to which the terminal device is to be handed over.

In Step 303, it is determined whether to execute the first n times of cell handover based on the first configuration information; and if it is determined to execute the first n times of cell handover based on the first configuration information, step 304 is executed; or if it is determined not to execute the first n times of cell handover based on the first configuration information, step 305 is executed, where n is an integer greater than or equal to 1.

In step 304, when the first n times of cell handover is executed based on the first configuration information, the terminal device is handed over to the target cell based on the first signalling, and the corresponding processing of the at least one protocol layer of the terminal device in a process of handing over to the target cell is determined.

In some embodiments, the first signalling includes first indication information, and the first indication information is used to indicate the corresponding processing of the at least one protocol layer. Exemplarily, the first indication information includes a first indication field, and the first indication field is used to indicate the corresponding processing of the at least one protocol layer of the terminal device. Exemplarily, the first indication field includes at least two indication bits, and the at least two indication bits are used to indicate the corresponding processing of the at least one protocol layer. Exemplarily, an indication manner of an indication bit includes at least one of the following: one indication bit is used to indicate corresponding processing of one protocol layer of the terminal device, one indication bit is used to indicate corresponding processing of a plurality of protocol layers of the terminal device, two or more indication bits are used to indicate corresponding processing of one protocol layer of the terminal device, or two or more indication bits are used to indicate corresponding processing of a plurality of protocol layers of the terminal device. Herein, the first signalling further includes second indication information, and the second indication information is used to indicate that the first candidate cell is used as the target cell.

In some embodiments, the first signalling includes first indication information, and the first indication information is used to indicate that the first candidate cell is used as the target cell. Exemplarily, when the at least one candidate cell is grouped into the at least one candidate cell group, and each candidate cell group includes at least one candidate cell, the first indication information includes an index of a candidate cell group to which the first candidate cell belongs and/or an index of the first candidate cell. That is, the first indication information indicates the corresponding processing of the at least one protocol layer by indicating the candidate cell group to which the first candidate cell belongs. It is determined, based on the candidate cell group to which the target cell belongs and the candidate cell group to which the source cell belongs, the corresponding processing of the at least one protocol layer of the terminal device in the process of handing over to the target cell.

Exemplarily, if the target cell and the source cell do not belong to a same candidate cell group, it is determined to execute the corresponding processing of the at least one protocol layer; or if the target cell and the source cell belong to a same candidate cell group, it is determined not to execute the corresponding processing of the at least one protocol layer. That is, in an implementation, the corresponding processing of the at least one protocol layer is pre-configured. When the target cell and the source cell do not belong to a same candidate cell group, it is determined to execute the corresponding processing of the at least one protocol layer; or when the target cell and the source cell belong to a same candidate cell group, it is determined not to execute the corresponding processing of the at least one protocol layer.

In some embodiments, the first signalling includes first indication information, and the first indication information is used to indicate that the first candidate cell is used as the target cell. The terminal device is handed over to the target cell based on the first signalling, corresponding processing of at least one protocol layer corresponding to the target cell is determined based on configuration information (the first configuration information or second configuration information), and the corresponding processing of the at least one protocol layer is executed.

It may be understood that, when a plurality of times of cell handover is executed according to a same set of candidate cell configurations, a network device triggers, by delivering first signalling, a terminal device to perform cell handover, and determines, based on the first signalling or configuration information, corresponding processing of at least one protocol layer of the terminal device in handover processes of the first n times of cell handover.

In step 305, when cell handover after the n^{th} time of handover is executed based on the first configuration information, the terminal device is handed over to the target cell based on the first signalling, and based on pre-defined information, the corresponding processing of the at least one protocol layer of the terminal device in the process of handing over to the target cell is determined.

It may be understood that, when n is equal to 1 and a plurality of times of cell handover is executed according to a set of candidate cell configurations, the corresponding processing of the at least one protocol layer of the terminal device is determined based on the first signalling in the first time of cell handover. In a non-first time of cell handover, the corresponding processing of the at least one protocol layer is determined based on the pre-defined information. Herein, the pre-defined information may be corresponding processing of at least one protocol layer that is to be executed by the terminal device by default during execution of cell handover and that is pre-defined in a protocol. For example, RLC re-establishment, PDCP data recovery, and MAC resetting are to be executed by default.

Exemplarily, it is determined, based on an indication of the first signalling, to execute one or more of RLC re-establishment, PDCP data recovery, MAC resetting, or MAC partial resetting. When layer 1 or layer 2 handover is executed subsequently, RLC re-establishment, PDCP data recovery, and MAC resetting are executed by default.

When n is greater than 1 and a plurality of times of cell handover is executed based on a set of candidate cell configurations of the first configuration information, the corresponding processing of the at least one protocol layer of the terminal device is determined based on the indication of the first signalling, in the first n times of cell handover. Starting from the (n+1)^{th} time of cell handover, the corresponding processing of the at least one protocol layer is determined based on the pre-defined information.

In some embodiments, the method further includes: when the first n times of cell handover is executed based on the first configuration information, determining, based on the pre-defined information, the corresponding processing of the at least one protocol layer of the terminal device in the process of handing over to the target cell; and when cell handover after the n^{th} time of handover is executed based on the first configuration information, determining the corresponding processing of the at least one protocol layer of the terminal device based on the indication of the first signalling.

It may be understood that, when a plurality of times of cell handover is executed according to a same set of candidate cell configurations, pre-defined corresponding processing of at least one protocol layer is executed in the first n times of cell handover. Starting from the (n+1)th time of cell handover, the corresponding processing of the at least one protocol layer of the terminal device is determined based on the indication of the first signalling.

By using the foregoing technical solution, when a plurality of times of cell handover is executed according to a same set of candidate cell configurations, a network device triggers, by delivering first signalling, a terminal device to perform cell handover. For handover of some cells, corresponding processing of at least one protocol layer of the terminal device in a handover process is determined based on the first signalling or configuration information; and for handover of the other cells, corresponding processing of at least one protocol layer that is pre-defined in a protocol is performed, to meet cell handover requirements in more scenarios, thereby implementing accurate configurations of the corresponding processing of the at least one protocol layer, and reducing a handover latency. In addition, the terminal device performs cell handover by using a layer 1 and/or a layer 2, which can reduce a latency in protocol stack processing and further reduce the handover latency.

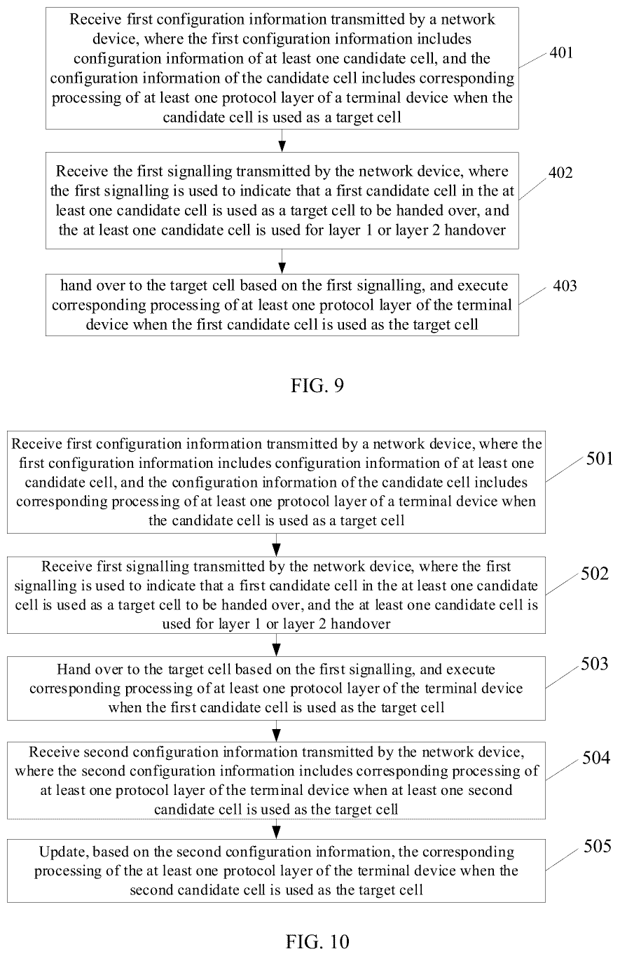

An embodiment of this application further provides a cell handover method, applied to a terminal device. In this method, a network device delivers configuration information of a candidate cell, where the configuration information of the candidate cell includes corresponding processing of at least one protocol layer of the terminal device when the candidate cell is used as a target cell. FIG. 9 is a fourth schematic flowchart of a cell handover method according to an embodiment of this application. As shown in FIG. 9, the cell handover method includes steps 401 to 403.

In step 401, first configuration information transmitted by a network device is received, where the first configuration information includes configuration information of at least one candidate cell, and the configuration information of the candidate cell includes corresponding processing of at least one protocol layer of a terminal device when the candidate cell is used as a target cell.

It may be understood that, the corresponding processing of the at least one protocol layer is pre-configured by the network device for the candidate cell. That is, a correspondence between each candidate cell and corresponding processing of a protocol layer is pre-configured. In this embodiment of this application, the corresponding processing of the at least one protocol layer includes at least one of the following: RLC re-establishment, PDCP data recovery, MAC resetting, MAC partial resetting, or MAC no resetting.

In some embodiments, before delivering first signalling to trigger cell handover, the network device first needs to transmit the first configuration information, where the first configuration information is used to configure a set of candidate cells for the terminal device, and the terminal device executes a plurality of times of handover according to a same set of candidate cell configurations in a specific area or within a period of time. Exemplarily, configuration information of each candidate cell includes at least one of the following: (a) an index of the candidate cell; (b) a measurement configuration of the candidate cell; or (c) configuration information dedicated to the candidate cell and/or configuration information dedicated to the terminal device. Exemplarily, the configuration information includes a cell identity, a C-RNTI of the cell, system information of the cell, a TAG ID, an uplink bandwidth, a downlink bandwidth configuration, an RLC layer configuration, a MAC layer configuration, a PHY layer configuration, and the like. Exemplarily, the first configuration information may be carried by an RRC message. In actual application, the at least one candidate cell configured by using the first configuration information includes or does not include a current serving cell.

In some embodiments, after the first configuration information transmitted by the network device is received, the method further includes: measuring, by the terminal device, all or some of candidate cells to obtain a cell measurement result, and reporting the cell measurement result to the network device, so that the network device executes a measurement decision according to the cell measurement result to determine the target cell, generates the first signalling, and delivers the first signalling to the terminal device to trigger cell handover. Exemplarily, the terminal device measures a downlink reference signal (an SSB or a CSI-RS) of all or some of the candidate cells, to obtain a measurement result at a beam or cell level.

In step 402, the first signalling transmitted by the network device is received, where the first signalling is used to indicate that a first candidate cell in the at least one candidate cell is used as the target cell to which the terminal device is to be handed over, and the at least one candidate cell is used for layer 1 or layer 2 handover.

Herein, the first signalling is used to trigger the terminal device to execute cell handover, and the first signalling is used to indicate that the first candidate cell in the at least one candidate cell is used as the target cell for performing handover. Exemplarily, the first signalling includes first indication information, and the first indication information is used to indicate that the first candidate cell is used as the target cell. The first indication information may be an index of the target cell, an ID of the target cell, an indication bit of the target cell, or the like. In some embodiments, the first signalling is carried by a medium access control control element and/or downlink control information.

In step 403, the terminal device is handed over to the target cell based on the first signalling, and corresponding processing of at least one protocol layer of the terminal device when the first candidate cell is used as the target cell is executed.

The first candidate cell is determined based on the first signalling, and corresponding processing of at least one protocol layer of the first candidate cell is obtained from configuration information of the first candidate cell.

In some embodiments, the method further includes: determining, based on the first configuration information, that the terminal device executes PDCP data recovery and triggers a PDCP status report in a process of handing over to the target cell.

In some embodiments, the method further includes: determining, based on the first configuration information, that the terminal device does not execute RLC re-establishment, PDCP data recovery, and MAC resetting in the process of handing over to the target cell, and determining, based on the first signalling, MAC resetting, MAC partial resetting, or MAC no resetting of the terminal device. That is, corresponding processing of some protocol layers may be configured by using the first configuration information, and corresponding processing of the other protocol layers may be indicated by the first indication information in the first signalling.

It may be understood that corresponding processing of protocol layers of a layer 2 may be all configured by using the first configuration information, or corresponding processing of some of the protocol layers is configured by using the first configuration information, and corresponding processing of the other protocol layers is indicated by the first indication information. For example, RLC re-establishment and PDCP data recovery are configured by using the first configuration information, while MAC resetting, MAC partial resetting, and MAC no resetting are indicated by the first indication information.

FIG. 10 is a fifth schematic flowchart of a cell handover method according to an embodiment of this application. As shown in FIG. 10, the cell handover method includes steps 501 to 505.

In step 501, first configuration information transmitted by a network device is received, where the first configuration information includes configuration information of at least one candidate cell, and the configuration information of the candidate cell includes corresponding processing of at least one protocol layer of a terminal device when the candidate cell is used as a target cell.

In step 502, first signalling transmitted by the network device is received, where the first signalling is used to indicate that a first candidate cell in the at least one candidate cell is used as the target cell to which the terminal device is to be handed over, and the at least one candidate cell is used for layer 1 or layer 2 handover.

In step 503, the terminal device is handed over to the target cell based on the first signalling, and corresponding processing of at least one protocol layer of the terminal device when the first candidate cell is used as the target cell is executed.

In step 504, second configuration information transmitted by the network device is received, where the second configuration information includes corresponding processing of at least one protocol layer of the terminal device when at least one second candidate cell is used as the target cell.

Herein, the second candidate cell is a candidate cell in the at least one candidate cell.

In step 505, based on the second configuration information, the corresponding processing of the at least one protocol layer of the terminal device when the second candidate cell is used as the target cell is updated.

The second configuration information is used to update the corresponding processing of the at least one protocol layer of the terminal device after the second candidate cell is used as the target cell. The second candidate cell is a candidate cell for which corresponding processing of a protocol layer needs to be updated. The corresponding processing of the protocol layer when the second candidate cell is used as the target cell is updated by using the second configuration information when each time of cell handover is completed or when it is determined that configuration information changes, thereby achieving the following effect: signalling overheads in a plurality of handover processes when a source cell changes are relatively low, because the second configuration information includes only information for updating the corresponding processing of the protocol layer of the second candidate cell. The second configuration information is carried by an RRC message or a MAC CE.

In one implementation, the second configuration information is used to indicate the at least one second candidate cell, and the at least one second candidate cell corresponds to the corresponding processing of the at least one protocol layer. Herein, the at least one second candidate cell corresponding to the corresponding processing of the at least one protocol layer may include: the corresponding processing of the at least one protocol layer that is to be executed by the terminal device in a process of handing over to the target cell is determined based on pre-defined information. Exemplarily, the second configuration information includes identity information of the second candidate cell. In another implementation, the second configuration information includes the identity information of the second candidate cell and indication information of the corresponding processing of the at least one protocol layer. That is, if the corresponding processing of the at least one protocol layer is pre-defined, the network device updates, by delivering the identity information of the second candidate cell, the corresponding processing of the at least one protocol layer of the terminal device that is required by the second candidate cell. If the corresponding processing of the at least one protocol layer cannot be pre-defined in a plurality of handover processes, the network device updates the corresponding processing of the at least one protocol layer of the second candidate cell by delivering the identity information of the second candidate cell and the indication information of the corresponding processing of the at least one protocol layer.

Exemplarily, the second configuration information includes a cell list, and the cell list includes the identity information of the at least one second candidate cell. Alternatively, the second configuration information includes a bitmap, and the bitmap is used to indicate the at least one second candidate cell.

The following further describes the second configuration information by using examples.

Choice 1: The second configuration information includes a list of indexes of candidate cells, as shown in Table 3. RLC re-establishment, PDCP data recovery, and MAC resetting need to be performed for the candidate cells in the list.

TABLE 3
List of indexes of candidate cells

Cell#1
Cell#3
Cell#4
Cell#6

Choice 2: The second configuration information includes a bitmap (bitmap), where the bitmap indicates corresponding processing of at least one protocol layer of each candidate cell. For example, if a bit is set to 1, RLC re-establishment, PDCP data recovery, and MAC resetting need to be performed for a corresponding candidate cell; or if a bit is set to 0, RLC re-establishment, PDCP data recovery, and MAC resetting are unnecessary to be performed for a corresponding candidate cell. Exemplarily, when eight candidate cells are included, the bitmap may be 10110100.

As shown in Table 4, if a bit is set to 1, it indicates that the terminal device needs to perform RLC re-establishment, PDCP data recovery, and MAC resetting when moving from Cell #1 to Cell #4 or Cell #5. After the terminal device moves to Cell #4, that is, a current serving cell changes from Cell #1 to Cell #4, the terminal device receives the second configuration information. In the second configuration information, Cell #2 and Cell #3 are updated to be candidate cells for which RLC re-establishment, PDCP data recovery, and MAC resetting need to be executed.

TABLE 4

| | |
|---|---|
| Current | Candidate cell |

| serving cell | Cell#2 | Cell#3 | Cell#4 | Cell#5 |
|---|---|---|---|---|
| Cell#1 | 0 | 0 | 1 | 1 |

Moving from Cell#1 to Cell#4 and receiving
the second configuration information

| | | |
|---|---|---|
| Cell#4 | 1 | 1 |

In some embodiments, the first configuration information is carried by an RRC message, and the second configuration information is carried by an RRC message or a MAC CE.

In some embodiments, when the second configuration information is carried by a MAC CE, the process of updating, based on the second configuration information, the corresponding processing of the at least one protocol layer of the terminal device when the second candidate cell is used as the target cell includes: receiving the second configuration information by using a MAC layer; and transmitting the second configuration information to an RRC layer by using the MAC layer, and updating, by using the RRC layer and based on the second configuration information, the corresponding processing of the protocol layer that is to be executed by the terminal device when the first candidate cell is used as the target cell and that is in the first configuration information; or storing the second configuration information by using the MAC layer.

That is, if the second configuration information is carried by a MAC CE, that is, updating is indicated by a MAC CE, a behavior of the terminal device includes at least one of the following:
Choice 1: The MAC layer transmits the second configuration information to the RRC layer, and the RRC layer updates configuration information of each candidate cell; or
Choice 2: The MAC layer stores update information, and determines the corresponding processing of the at least one protocol layer based on an updated configuration after receiving the first signalling. Further, the MAC layer notifies the RRC layer that the RRC layer instructs each protocol layer to execute a corresponding behavior, or the MAC layer directly instructs each protocol layer to execute a corresponding behavior.

In some embodiments, the method further includes: determining, based on the first configuration information or the second configuration information, that the terminal device executes PDCP data recovery and triggers a PDCP status report in the process of handing over to the target cell.

In some embodiments, the method further includes: determining, based on the first configuration information or the second configuration information, that the terminal device does not execute RLC re-establishment, PDCP data recovery, and MAC resetting in the process of handing over to the target cell, and determining, based on the first signalling, MAC resetting, MAC partial resetting, or MAC no resetting of the terminal device. That is, corresponding processing of some protocol layers may be configured by using the first configuration information or the second configuration information, and corresponding processing of the other protocol layers may be indicated by the first indication information.

It may be understood that corresponding processing of protocol layers of a layer 2 may be all configured by using the first configuration information and/or the second configuration information, or corresponding processing of some of the protocol layers is configured by using the first configuration information and/or the second configuration information, and corresponding processing of the other protocol layers is indicated by the first indication information. For example, RLC re-establishment and PDCP data recovery are configured by using the first configuration information, while MAC resetting, MAC partial resetting, and MAC no resetting are indicated by the first indication information.

By using the foregoing technical solution, when a plurality of times of cell handover is executed according to a same set of candidate cell configurations, a network device pre-configures corresponding processing of a protocol layer of a candidate cell by using first configuration information, and the network device triggers, by delivering first signalling, a terminal device to perform cell handover. Each time after cell handover is executed, the network device updates, by delivering second configuration information, the corresponding processing of the protocol layer of the candidate cell, thereby resolving a problem that corresponding processing of at least one protocol layer changes with changing of a source cell when a candidate cell is used as a target cell, in a plurality of handover processes, implementing accurate configurations of the corresponding processing of the at least one protocol layer, and thus reducing a handover latency. In addition, compared with cell handover triggered by using layer 3 signalling, cell handover triggered by using layer 1 signalling and/or layer 2 signalling can reduce a latency in protocol stack processing and therefore reduce a cell handover latency.

In this embodiment of this application, a PDCP data recovery procedure includes at least: a PDCP layer retransmits PDCP data PDUs in ascending order of COUNT values (counter values) associated with the packet data units (PDU). The PDUs were previously delivered to an RLC entity on which a re-establishment or releasing acknowledgement mode (AM) occurred, and an indication from an underlying layer that acknowledges successful reception was not received.

An RLC re-establishment procedure includes at least: discarding all RLC service data units (SDUs), RLC SDU segments, and RLD PDUs if any; stopping and resetting all timers; and resetting all status variables to initial values.

A MAC resetting procedure includes at least: stopping all timers (timer) (if running); considering all TA timeout timers (TimeAlignmentTimer) as expired and executing corresponding operations in Section 5.2; setting NDIs of all uplink (UL) HARQ processes to 0; stopping ongoing random access programs if any; for a four-step RA type and a two-step RA type (if any), discarding contention-free random access resources of explicit signalling; refreshing a Msg3 buffer; refreshing an MSGA buffer; canceling triggered scheduling request processes if any; canceling triggered buffer status report programs if any; canceling triggered power clearance report programs if any; canceling triggered consistent LBT faults if any; canceling triggered BFR if any; canceling triggered preemptive buffer status report programs if any; canceling triggered recommended bit rate query processes if any; canceling triggered configured uplink grant acknowledgements if any; canceling triggered query of required protection symbols if any; refreshing soft buffers of all downlink (DL) HARQ processes; for each DL HARQ process, considering a next time of reception transmission of a TB as the first time of transmission; releasing a temporary C-RNTI if any; resetting all BFI counters; and resetting all LBT counters.

An embodiment of this application further provides a cell handover method, applied to a network device, where the cell handover method includes: transmitting first signalling to a terminal device, so that the terminal device is handed over to a target cell based on the first signalling; and determining corresponding processing of at least one protocol layer of the terminal device in a process of handing over to the target cell.

The first signalling is used to indicate that a first candidate cell in at least one candidate cell is used as the target cell to which the terminal device is to be handed over, and the at least one candidate cell is used for layer 1 or layer 2 handover. Herein, the first signalling is used to trigger the terminal device to execute cell handover. Exemplarily, the first signalling is layer 1 (L1) signalling and/or layer 2 (L2) signalling. When cell handover is triggered by using layer 1 signalling and/or layer 2 signalling, the terminal device executes cell handover processing by using a layer 1 and/or a layer 2, which can reduce a latency in protocol stack processing and therefore reduce a cell handover latency. In a handover process triggered by L3 signalling (RRCReconfiguration), after the terminal device receives the L3 signalling, corresponding processing of each protocol layer needs to be performed in a process of handing over to the target cell, and a latency in protocol stack processing is relatively large, resulting in a relatively large handover latency. Therefore, compared with cell handover triggered by using L3 signalling, cell handover triggered by using layer 1 signalling and/or layer 2 signalling can reduce a latency in protocol stack processing and therefore reduce a cell handover latency.

Herein, the at least one candidate cell is one or more candidate cells configured by the network device within a period of time or in a specific area. The terminal device determines the target cell in a same set of candidate cells within the period of time or in the specific area, and performs a plurality of times of cell handover.

In some embodiments, before the transmitting first signalling to a terminal device, the method further includes: transmitting first configuration information to the terminal device, where the first configuration information includes configuration information of the at least one candidate cell.

In some embodiments, after the first configuration information transmitted by the network device is received, the method further includes: measuring, by the terminal device, all or some of candidate cells to obtain a cell measurement result, and reporting the cell measurement result to the network device, so that the network device executes a measurement decision according to the cell measurement result to determine the target cell, generates the first signalling, and delivers the first signalling to the terminal device to trigger cell handover. Exemplarily, it is determined, based on first indication information, that the terminal device executes PDCP data recovery and triggers a PDCP status report in the process of handing over to the target cell. Specifically, when an upper layer requests re-establishment of a PDCP entity or the upper layer requests PDCP data recovery, the PDCP status report is triggered and the PDCP status report is transmitted on an uplink.

Herein, the at least one protocol layer is a protocol layer in the layer 2, and includes an RLC layer, a PDCP layer, and a MAC layer. Correspondingly, the corresponding processing of the protocol layer includes at least one of the following: RLC re-establishment (Re-establish), PDCP data recovery (Data recovery), MAC resetting (Reset), MAC partial resetting (Partial reset), MAC no resetting, or PDCP layer re-establishment. Exemplarily, MAC partial resetting includes at least one of the following: clearing a hybrid automatic repeat request (HARQ) buffer, canceling triggered beam failure recovery (BFR), or canceling a triggered scheduling request (SR).

In some embodiments, the first signalling is further used to indicate the corresponding processing of the at least one protocol layer of the terminal device in the process of handing over to the target cell. Exemplarily, the first signalling includes first indication information, and the first indication information is used to indicate the corresponding processing of the at least one protocol layer. The first signalling is layer 1 signalling and/or layer 2 signalling. That is, the network device carries information about cell handover by using layer 1 signalling and/or layer 2 signalling, and transmits the information to the terminal device, to trigger the terminal device to execute cell handover. The first indication information is a MAC CE and/or DCI.

It may be understood that, in one case, the first indication information may be used to indicate whether the terminal device executes the corresponding processing of the at least one protocol layer. In another case, the first indication information indicates the corresponding processing of the at least one protocol layer that is to be executed. Exemplarily, the corresponding processing of the at least one protocol layer includes RLC re-establishment, PDCP data recovery, and MAC resetting. The first indication information is used to instruct to execute RLC re-establishment, PDCP data recovery, and MAC resetting in the process of handing over to the target cell, or is used to instruct not to execute RLC re-establishment, PDCP data recovery, and MAC resetting.

Exemplarily, the first indication information includes a first indication field, and the first indication field is used to indicate the corresponding processing of the at least one protocol layer. Exemplarily, the first indication field may include one or more indication bits. A quantity of bits occupied by the first indication field is not specifically limited in embodiments of this application. In an implementation in which the first indication field includes two or more indication bits, a location relationship between the indication bits is not limited.

In some embodiments, the first indication field includes at least two indication bits, and the at least two indication bits are used to indicate the corresponding processing of the at least one protocol layer. Exemplarily, an indication manner of an indication bit includes at least one of the following: one indication bit is used to indicate corresponding processing of one protocol layer of the terminal device, one indication bit is used to indicate corresponding processing of a plurality of protocol layers of the terminal device, two or more indication bits are used to indicate corresponding processing of one protocol layer of the terminal device, or two or more indication bits are used to indicate corresponding processing of a plurality of protocol layers of the terminal device.

When the first indication field includes two or more indication bits, the first indication field can carry more information, to more flexibly indicate the corresponding processing of the at least one protocol layer. That is, when an optional range of the corresponding processing of the at least one protocol layer includes corresponding processing of more than two protocol layers, for example, the first type is to execute RLC re-establishment, the second type is to execute PDCP data recovery, the third type is to execute RLC re-establishment and PDCP data recovery, and the fourth type is to execute RLC re-establishment, PDCP data recovery, MAC resetting, and the like. Each indication bit may be used to indicate one or more operations, or at least two indication bits form an entity to indicate the corresponding processing of the at least one protocol layer.

In some embodiments, the process of determining corresponding processing of at least one protocol layer of the terminal device in a process of handing over to the target cell includes: determining, based on pre-defined information, the corresponding processing of the at least one protocol layer that is to be executed by the terminal device in the process of handing over to the target cell. The pre-defined information may be corresponding processing of at least one protocol layer that is to be executed by the terminal device by default during execution of cell handover and that is pre-defined in a protocol. For example, RLC re-establishment, PDCP data recovery, and MAC resetting are to be executed by default.

In some embodiments, corresponding processing of protocol layers may be all pre-defined in a protocol. Alternatively, corresponding processing of some of the protocol layers is pre-defined in a protocol, and corresponding processing of the other protocol layers is indicated by the first indication information. For example, RLC re-establishment and PDCP data recovery are indicated by the first indication information, while MAC resetting, MAC partial resetting, and MAC no resetting are pre-defined in a protocol.

In some embodiments, the method further includes: determining, based on the first indication information, that the terminal device executes PDCP data recovery and triggers a PDCP status report in the process of handing over to the target cell. Specifically, when an upper layer requests re-establishment of a PDCP entity or the upper layer requests PDCP data recovery, the PDCP status report is triggered and the PDCP status report is transmitted on an uplink.

By using the foregoing technical solution, when a plurality of times of cell handover is executed according to a same set of candidate cell configurations, a network device triggers, by delivering first signalling (layer 1 signalling or layer 2 signalling), a terminal device to perform cell handover, and determines, based on the first signalling, corresponding processing of at least one protocol layer of the terminal device in a handover process, thereby resolving a problem that corresponding processing of at least one protocol layer changes with changing of a source cell when a candidate cell is used as a target cell, in a plurality of handover processes, implementing accurate configurations of the corresponding processing of the at least one protocol layer, and thus reducing a handover latency. In addition, compared with cell handover triggered by using layer 3 signalling, cell handover triggered by using layer 1 signalling and/or layer 2 signalling can reduce a latency in protocol stack processing and therefore reduce a cell handover latency.

An embodiment of this application further provides a cell handover method, applied to a network device, where the cell handover method includes:
transmitting first configuration information to a terminal device, where the first configuration information includes configuration information of at least one candidate cell; and transmitting first signalling to the terminal device, so that the terminal device is handed over to a target cell based on the first signalling, and determining corresponding processing of at least one protocol layer of the terminal device in a process of handing over to the target cell.

The first configuration information further includes configuration information of at least one candidate cell group, and configuration information of each candidate cell group includes configuration information of at least one candidate cell. The at least one candidate cell is grouped into the at least one candidate cell group by using the first configuration information, and the terminal device determines, based on a candidate cell group to which the target cell belongs and a candidate cell group to which a source cell belongs, the corresponding processing of the at least one protocol layer of the terminal device. Exemplarily, the first configuration information is carried by an RRC message.

It may be understood that before delivering the first signalling to trigger cell handover, the network device first needs to transmit the first configuration information, where the first configuration information is used to configure a set of candidate cells for the terminal device, and the terminal device executes a plurality of times of handover according to a same set of candidate cell configurations in a specific area or within a period of time. Exemplarily, configuration information of each candidate cell includes at least one of the following: (a) an index of the candidate cell; (b) a measurement configuration of the candidate cell; or (c) configuration information dedicated to the candidate cell and/or configuration information dedicated to the terminal device. Exemplarily, the configuration information includes a cell identity, a C-RNTI of the cell, system information of the cell, a TAG ID, an uplink bandwidth, a downlink bandwidth configuration, an RLC layer configuration, a MAC layer configuration, a PHY layer configuration, and the like. Exemplarily, the first configuration information may be carried by an RRC message. In actual application, the at least one candidate cell configured by using the first configuration information includes or does not include a current serving cell.

In some embodiments, after the first configuration information transmitted by the network device is received, the method further includes: measuring, by the terminal device, all or some of candidate cells to obtain a cell measurement result, and reporting the cell measurement result to the network device, so that the network device executes a measurement decision according to the cell measurement result to determine the target cell, generates the first signalling, and delivers the first signalling to the terminal device to trigger cell handover. Exemplarily, the terminal device measures a downlink reference signal (an SSB or a CSI-RS) of all or some of the candidate cells, to obtain a measurement result at a beam or cell level.

The first signalling is used to indicate that a first candidate cell in the at least one candidate cell is used as the target cell to which the terminal device is to be handed over, and the at least one candidate cell is used for layer 1 or layer 2 handover; and
the first signalling is further used to indicate the corresponding processing of the at least one protocol layer of the terminal device in the process of handing over to the target cell.

Exemplarily, the first indication information includes an index of a candidate cell group to which the first candidate cell belongs and/or an index of the first candidate cell. That is, the first indication information indicates the corresponding processing of the at least one protocol layer by indicating the candidate cell group to which the first candidate cell belongs.

It may be understood that, candidate cells are grouped into groups, grouping configuration is performed on corresponding processing of protocol layers according to the candidate cell groups, and the corresponding processing of the at least one protocol layer is determined based on the candidate cell group to which the target cell belongs and the candidate cell group to which the source cell belongs.

The at least one candidate cell is grouped into the at least one candidate cell group, and each candidate cell group includes at least one candidate cell. The method further includes: determining, based on the candidate cell group to which the target cell belongs and the candidate cell group to which the source cell belongs, the corresponding processing of the at least one protocol layer of the terminal device in the process of handing over to the target cell.

In some embodiments, the process of determining, based on the candidate cell group to which the target cell belongs and the candidate cell group to which the source cell belongs, the corresponding processing of the at least one protocol layer of the terminal device in the process of handing over to the target cell includes: determining that the target cell and the source cell belong to a first candidate cell group; determining corresponding processing of at least one protocol layer corresponding to the first candidate cell group; determining that the target cell belongs to a second candidate cell group, determining that the source cell belongs to a third candidate cell group, and determining the corresponding processing of the at least one protocol layer based on the second candidate cell group and the third candidate cell group. Exemplarily, corresponding processing of a same protocol layer or different protocol layers may be configured for different candidate cell groups. When the target cell and the source cell belong to a same candidate cell group, corresponding processing of a protocol layer corresponding to the candidate cell group is obtained; or when the target cell and the source cell do not belong to a same candidate cell group, the corresponding processing of the at least one protocol layer is determined based on the candidate cell group to which the target cell belongs, the candidate cell group to which the source cell belongs, and a cell handover principle between the candidate cell groups.

Exemplarily, the corresponding processing of the protocol layer corresponding to the first candidate cell group includes not executing RLC re-establishment and PDCP data recovery, corresponding processing of a protocol layer corresponding to the second candidate cell group includes executing RLC re-establishment and PDCP data recovery, and corresponding processing of a protocol layer corresponding to the third candidate cell group includes executing RLC re-establishment, PDCP data recovery, and MAC resetting.

Exemplarily, the cell handover principle between the candidate cell groups includes: when it is handed over from the first candidate cell group to the second candidate cell group, corresponding processing of a respective protocol layer includes executing RLC re-establishment; when it is handed over from the second candidate cell group to the third candidate group, corresponding processing of a respective protocol layer includes executing RLC re-establishment, PDCP data recovery, and MAC resetting.

In some embodiments, the process of determining, based on the candidate cell group to which the target cell belongs and the candidate cell group to which the source cell belongs, the corresponding processing of the at least one protocol layer of the terminal device in the process of handing over to the target cell includes: if the target cell and the source cell do not belong to a same candidate cell group, determining to execute the corresponding processing of the at least one protocol layer; or if the target cell and the source cell belong to a same candidate cell group, determining not to execute the corresponding processing of the at least one protocol layer.

In some embodiments, the network device may pre-configure corresponding processing of one or more types of protocol layers by grouping candidate cells into groups, determine, based on the candidate cell group to which the target cell belongs and the candidate cell group to which the source cell belongs, the corresponding processing of the at least one protocol layer of the terminal device, and generate the first signalling used to indicate the corresponding processing of the at least one protocol layer.

In some embodiments, the first indication information may be further used to indicate the corresponding processing of the at least one protocol layer. It may be understood that corresponding processing of protocol layers of a layer 2 may be all pre-configured by grouping the candidate cells into groups, or corresponding processing of some of the protocol layers is pre-configured by grouping the candidate cells into groups, and corresponding processing of the other protocol layers is indicated by the first indication information. For example, RLC re-establishment and PDCP data recovery are pre-configured by grouping the candidate cells into groups, while MAC resetting, MAC partial resetting, and MAC no resetting are indicated by the first indication information.

Exemplarily, the first indication information may include first sub-indication information and second sub-indication information, where the first sub-indication information is used to indicate the index of the candidate cell group to which the first candidate cell belongs and/or the index of the first candidate cell, and the second sub-indication information is used to indicate the corresponding processing of the at least one protocol layer of the terminal device.

By using the foregoing technical solution, when a plurality of times of cell handover is executed according to a same set of candidate cell configurations, a network device pre-configures corresponding processing of one or more types of protocol layers by grouping candidate cells into groups, triggers, by delivering first signalling, a terminal device to perform cell handover, and determines, based on the first signalling, corresponding processing of at least one protocol layer of the terminal device in a handover process, thereby resolving a problem that corresponding processing of at least one protocol layer changes with changing of a source cell when a candidate cell is used as a target cell, in a plurality of handover processes, implementing accurate configurations of the corresponding processing of the at least one protocol layer, and thus reducing a handover latency. In addition, compared with cell handover triggered by using layer 3 signalling, cell handover triggered by using layer 1 signalling and/or layer 2 signalling can reduce a latency in protocol stack processing and therefore reduce a cell handover latency.

An embodiment of this application further provides a cell handover method, applied to a network device, where the cell handover method includes: transmitting first configuration information to a terminal device; and transmitting first signalling to the terminal device. When the terminal device executes the first n times of cell handover based on the first configuration information, the terminal device is handed over to a target cell based on the first signalling, and determines corresponding processing of at least one protocol layer of the terminal device in a process of handing over to the target cell; and when the terminal device executes cell handover after the n^{th} time of handover based on the first configuration information, the terminal device is handed over to the target cell based on the first signalling, and determines, based on pre-defined information, to execute the corresponding processing of the at least one protocol layer in the process of handing over to the target cell, where n is an integer greater than or equal to 1.

It may be understood that, when n is equal to 1 and a plurality of times of cell handover is executed according to a set of candidate cell configurations, the corresponding processing of the at least one protocol layer of the terminal device is determined based on the first signalling in the first time of cell handover. In a non-first time of cell handover, whether to execute the corresponding processing of the at least one protocol layer is determined based on protocol pre-defining. Herein, whether to execute the corresponding processing of the at least one protocol layer being determined based on protocol pre-defining may be understood as a type of default processing, for example, executing RLC re-establishment, PDCP data recovery, and MAC resetting.

Exemplarily, it is determined, based on an indication of the first signalling, to execute one or more of RLC re-establishment, PDCP data recovery, MAC resetting, or MAC partial resetting. When layer 1 or layer 2 handover is executed subsequently, RLC re-establishment, PDCP data recovery, and MAC resetting are executed by default.

When n is greater than 1 and a plurality of times of cell handover is executed based on a set of candidate cell configurations of the first configuration information, the corresponding processing of the at least one protocol layer of the terminal device is determined based on the indication of the first signalling in the first n times of cell handover. Starting from the (n+1)th time of cell handover, whether to execute the corresponding processing of the at least one protocol layer is determined based on protocol pre-defining.

In some other embodiments, when the first n times of cell handover is executed based on the first configuration information, pre-defined corresponding processing of at least one protocol layer is executed; and when cell handover after the n^{th} time of handover is executed based on the first configuration information, the corresponding processing of the at least one protocol layer of the terminal device is determined based on the indication of the first signalling.

It may be understood that, when a plurality of times of cell handover is executed according to a same set of candidate cell configurations, pre-defined corresponding processing of at least one protocol layer is executed in the first n times of cell handover. Starting from the (n+1)th time of cell handover, the corresponding processing of the at least one protocol layer of the terminal device is determined based on the indication of the first signalling.

By using the foregoing technical solution, when a plurality of times of cell handover is executed according to a same set of candidate cell configurations, a network device triggers, by delivering first signalling, a terminal device to perform cell handover. For handover of some cells, corresponding processing of at least one protocol layer of the terminal device is determined based on an indication of the first signalling, grouping of candidate cells, or configuration information; and for handover of the other cells, corresponding processing of at least one protocol layer that is pre-defined in a protocol is performed, to meet cell handover requirements in more scenarios, thereby implementing accurate configurations of the corresponding processing of the at least one protocol layer, and reducing a handover latency. In addition, the terminal device performs cell handover by using a layer 1 and/or a layer 2, which can reduce a latency in protocol stack processing and further reduce the handover latency.

An embodiment of this application further provides a cell handover method, applied to a network device, where the cell handover method includes: transmitting first configuration information to a terminal device, where the first configuration information includes configuration information of at least one candidate cell, and the configuration information of the candidate cell includes corresponding processing of at least one protocol layer of the terminal device when the candidate cell is used as a target cell; and transmitting first signalling to the terminal device, where the first signalling is used to indicate that a first candidate cell in the at least one candidate cell is used as the target cell to which the terminal device is to be handed over, and the at least one candidate cell is used for layer 1 or layer 2 handover. That is, the terminal device is handed over to the target cell based on the first signalling, and executes corresponding processing of at least one protocol layer of the terminal device when the first candidate cell is used as the target cell.

It may be understood that, the corresponding processing of the at least one protocol layer is pre-configured by the network device for the candidate cell. That is, a correspondence between each candidate cell and corresponding processing of a protocol layer is pre-configured. In this embodiment of this application, the corresponding processing of the at least one protocol layer includes at least one of the following: RLC re-establishment, PDCP data recovery, MAC resetting, MAC partial resetting, or MAC no resetting.

Herein, the first signalling is used to trigger the terminal device to execute cell handover, and the first signalling is used to indicate that the first candidate cell in the at least one candidate cell is used as the target cell to which the terminal device is to be handed over. Exemplarily, the first signalling includes first indication information, and the first indication information is used to indicate that the first candidate cell is used as the target cell. The first indication information may be an index of the target cell, an ID of the target cell, an indication bit of the target cell, or the like. In some embodiments, the first signalling is carried by a medium access control control element and/or downlink control information.

The first candidate cell is determined based on the first signalling, and corresponding processing of at least one protocol layer of the first candidate cell is obtained from configuration information of the first candidate cell.

In some embodiments, the method further includes: determining, based on the first configuration information, that the terminal device executes PDCP data recovery and triggers a PDCP status report in a process of handing over to the target cell.

In some embodiments, the method further includes: determining, based on the first configuration information, that the terminal device does not execute RLC re-establishment, PDCP data recovery, and MAC resetting in the process of handing over to the target cell, and determining, based on the first signalling, MAC resetting, MAC partial resetting, or MAC no resetting of the terminal device. That is, corresponding processing of some protocol layers may be configured by using the first configuration information, and corresponding processing of the other protocol layers may be indicated by the first indication information in the first signalling.

It may be understood that corresponding processing of protocol layers of a layer 2 may be all configured by using the first configuration information, or corresponding processing of some of the protocol layers is configured by using the first configuration information, and corresponding processing of the other protocol layers is indicated by the first indication information. For example, RLC re-establishment and PDCP data recovery are configured by using the first configuration information, while MAC resetting, MAC partial resetting, and MAC no resetting are indicated by the first indication information.

In some embodiments, after the terminal device is handed over to the target cell based on the first signalling, the method further includes: transmitting second configuration information to the terminal device, where the second configuration information includes corresponding processing of at least one protocol layer of the terminal device when at least one second candidate cell is used as the target cell, and the second candidate cell is a candidate cell in the at least one candidate cell; and the second configuration information is used to update the corresponding processing of the at least one protocol layer of the terminal device when the second candidate cell is used as the target cell.

The second configuration information is used to update the corresponding processing of the at least one protocol layer of the terminal device after the second candidate cell is used as the target cell. The second candidate cell is a candidate cell for which corresponding processing of a protocol layer needs to be updated. The corresponding processing of the protocol layer when the second candidate cell is used as the target cell is updated by using the second configuration information when each time of cell handover is completed or when it is determined that configuration information changes, thereby achieving the following effect: signalling overheads in a plurality of handover processes when a source cell changes are relatively low, because the second configuration information includes only information for updating the corresponding processing of the protocol layer of the second candidate cell. The second configuration information is carried by an RRC message or a MAC CE.

In one implementation, the second configuration information is used to indicate the at least one second candidate cell, and the at least one second candidate cell corresponds to the corresponding processing of the at least one protocol layer. Herein, the at least one second candidate cell corresponding to the corresponding processing of the at least one protocol layer may include: the corresponding processing of the at least one protocol layer that is to be executed by the terminal device in a process of handing over to the target cell is determined based on pre-defined information. Exemplarily, the second configuration information includes identity information of the second candidate cell. In another implementation, the second configuration information includes the identity information of the second candidate cell and indication information of the corresponding processing of the at least one protocol layer. That is, if the corresponding processing of the at least one protocol layer is pre-defined, the network device updates, by delivering the identity information of the second candidate cell, the corresponding processing of the at least one protocol layer of the terminal device that is required by the second candidate cell. If the corresponding processing of the at least one protocol layer cannot be pre-defined in a plurality of handover processes, the network device updates the corresponding processing of the at least one protocol layer of the second candidate cell by delivering the identity information of the second candidate cell and the indication information of the corresponding processing of the at least one protocol layer.

In some embodiments, the second configuration information includes a cell list, and the cell list includes the identity information of the at least one second candidate cell. Alternatively, the second configuration information includes a bitmap, and the bitmap is used to indicate the at least one second candidate cell.

In some embodiments, the first configuration information is carried by an RRC message, and the second configuration information is carried by an RRC message or a MAC CE.

In some embodiments, when the second configuration information is carried by a MAC CE, the terminal device receives the second configuration information by using a MAC layer, transmits the second configuration information to an RRC layer by using the MAC layer, and updates, by using the RRC layer and based on the second configuration information, corresponding processing of at least one protocol layer of the terminal device when a second candidate cell is used as the target cell in the first configuration information; or the terminal device stores the second configuration information by using the MAC layer.

That is, if the second configuration information is carried by a MAC CE, that is, updating is indicated by a MAC CE, a behavior of the terminal device includes at least one of the following:
Choice 1: The MAC layer transmits the second configuration information to the RRC layer, and the RRC layer updates configuration information of each candidate cell; or
Choice 2: The MAC layer stores update information, and determines the corresponding processing of the at least one protocol layer based on an updated configuration after receiving the first signalling. Further, the MAC layer notifies the RRC layer that the RRC layer instructs each protocol layer to execute a corresponding behavior, or the MAC layer directly instructs each protocol layer to execute a corresponding behavior.

In some embodiments, the method further includes: determining, based on the first configuration information or the second configuration information, that the terminal device executes PDCP data recovery and triggers a PDCP status report in the process of handing over to the target cell.

In some embodiments, the method further includes: determining, based on the first configuration information or the second configuration information, that the terminal device does not execute RLC re-establishment, PDCP data recovery, and MAC resetting in the process of handing over to the target cell, and determining, based on the first signalling, MAC resetting, MAC partial resetting, or MAC no resetting of the terminal device. That is, corresponding processing of some protocol layers may be configured by using the first configuration information or the second configuration information, and corresponding processing of the other protocol layers may be further indicated by the first indication information.

In some embodiments, the method further includes: determining, based on the first configuration information or the second configuration information, that the terminal device does not execute RLC re-establishment, PDCP data recovery, and MAC resetting in the process of handing over to the target cell, and determining, based on the first signalling, MAC resetting, MAC partial resetting, or MAC no resetting of the terminal device. That is, corresponding processing of some protocol layers may be configured by using the first configuration information or the second configuration information, and corresponding processing of the other protocol layers may be indicated by the first indication information.

It may be understood that corresponding processing of protocol layers of a layer 2 may be all configured by using the first configuration information and/or the second configuration information, or corresponding processing of some protocol layers is configured by using the first configuration information and/or the second configuration information, and corresponding processing of the other protocol layers is indicated by the first indication information. For example, RLC re-establishment and PDCP data recovery are configured by using the first configuration information, while MAC resetting, MAC partial resetting, and MAC no resetting are indicated by the first indication information.

Exemplarily, the first indication information may include first sub-indication information and second sub-indication information, where the first sub-indication information is used to indicate that the first candidate cell is used as the target cell, and the second sub-indication information is used to indicate the corresponding processing of the at least one protocol layer of the terminal device.

By using the foregoing technical solution, when a plurality of times of cell handover is executed according to a same set of candidate cell configurations, a network device pre-configures corresponding processing of a protocol layer of a candidate cell by using first configuration information, and the network device triggers, by delivering first signalling, a terminal device to perform cell handover. Each time after cell handover is executed, the network device updates, by delivering second configuration information, the corresponding processing of the protocol layer of the candidate cell, thereby resolving a problem that corresponding processing of at least one protocol layer changes with changing of a source cell when a candidate cell is used as a target cell, in a plurality of handover processes, implementing accurate configurations of the corresponding processing of the at least one protocol layer, and thus reducing a handover latency. In addition, compared with cell handover triggered by using layer 3 signalling, cell handover triggered by using layer 1 signalling and/or layer 2 signalling can reduce a latency in protocol stack processing and therefore reduce a cell handover latency.

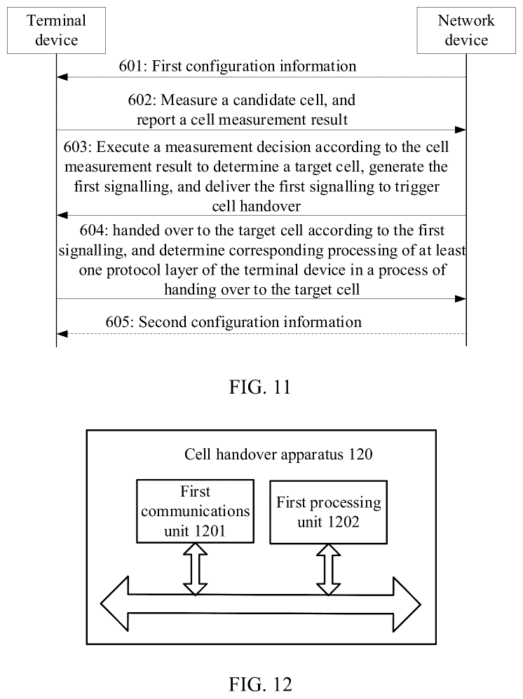

Based on the foregoing embodiments, an embodiment of this application further provides a cell handover method, applied to a communications system. FIG. 11 is a sixth schematic flowchart of a cell handover method according to an embodiment of this application. As shown in FIG. 11, the cell handover method includes steps 601 to 605.

In step 601, a network device transmits first configuration information to a terminal device.

In some embodiments, the first configuration information is used to configure a set of candidate cells for the terminal device, and the terminal device executes a plurality of times of handover according to a same set of candidate cell configurations in a specific area or within a period of time. Exemplarily, configuration information of each candidate cell includes at least one of the following: (a) an index of the candidate cell; (b) a measurement configuration of the candidate cell; or (c) configuration information dedicated to the candidate cell and/or configuration information dedicated to the terminal device. Exemplarily, the configuration information includes a cell identity, a C-RNTI of the cell, system information of the cell, a TAG ID, an uplink bandwidth, a downlink bandwidth configuration, an RLC layer configuration, a MAC layer configuration, a PHY layer configuration, and the like. Exemplarily, the first configuration information may be carried by an RRC message. In actual application, at least one candidate cell configured by using the first configuration information includes or does not include a current serving cell.

In some embodiments, the configuration information of the candidate cell includes corresponding processing of the at least one protocol layer of the terminal device when the candidate cell is used as a target cell. It may be understood that, the corresponding processing of the at least one protocol layer is corresponding processing of one or more protocol layers that is pre-configured by the network device, and a correspondence between each candidate cell and corresponding processing of a protocol layer may be pre-configured, or may be indicated by first signalling. In this embodiment of this application, the corresponding processing of the at least one protocol layer includes at least one of the following: RLC re-establishment, PDCP data recovery, MAC resetting, MAC partial resetting, or MAC no resetting.

In some embodiments, the first configuration information further includes configuration information of at least one candidate cell group, and configuration information of each candidate cell group includes configuration information of at least one candidate cell. The at least one candidate cell is grouped into the at least one candidate cell group by using the first configuration information, and the terminal device determines, based on a candidate cell group to which the target cell belongs and a candidate cell group to which a source cell belongs, corresponding processing of at least one protocol layer of the terminal device. Exemplarily, the first configuration information is carried by an RRC message.

In step 602, the terminal device measures all or some of candidate cells, and reports a cell measurement result.

Exemplarily, the terminal device measures a downlink reference signal (an SSB or a CSI-RS) of all or some of the candidate cells, to obtain a measurement result at a beam or cell level.

In step 603, the network device executes a measurement decision according to the cell measurement result to determine the target cell, generates the first signalling, and delivers the first signalling to trigger cell handover.

In step 604, the terminal device receives the first signalling, is handed over to the target cell according to the first signalling, and determines the corresponding processing of the at least one protocol layer of the terminal device in a process of handing over to the target cell.

Herein, the first signalling is used to trigger the terminal device to execute cell handover, and is used to indicate that a first candidate cell in the at least one candidate cell is used as the target cell to which the terminal device is to be handed over.

In some embodiments, the first signalling is further used to indicate the corresponding processing of the at least one protocol layer of the terminal device. Exemplarily, the first signalling includes first indication information, and the first indication information is used to indicate the corresponding processing of the at least one protocol layer of the terminal device.

It may be understood that, in one case, the first indication information may be used to indicate whether the terminal device executes the corresponding processing of the at least one protocol layer. In another case, the first indication information indicates the corresponding processing of the at least one protocol layer that is to be executed.

Exemplarily, the corresponding processing of the at least one protocol layer includes RLC re-establishment, PDCP data recovery, and MAC resetting. The first indication information is used to instruct to execute RLC re-establishment, PDCP data recovery, and MAC resetting in the process of handing over to the target cell, or is used to instruct not to execute RLC re-establishment, PDCP data recovery, and MAC resetting.

Exemplarily, the first indication information includes a first indication field, and the first indication field is used to indicate the corresponding processing of the at least one protocol layer of the terminal device. That is, the first indication field is used to indicate at least one of the following behaviors of the terminal device in a cell handover process executed by the terminal device: RLC re-establishment, PDCP data recovery, MAC resetting, MAC partial resetting, or MAC no resetting. Exemplarily, MAC partial resetting includes: clearing a HARQ buffer, canceling triggered BFR, or the like.

Herein, the first indication field may include one or more indication bits. A quantity of bits occupied by the first indication field is not specifically limited in embodiments of this application. In an implementation in which the first indication field includes two or more indication bits, a location relationship between the indication bits is not limited.

Exemplarily, the first indication information may include first sub-indication information and second sub-indication information, where the first sub-indication information is used to indicate that the first candidate cell is used as the target cell, and the second sub-indication information is used to indicate the corresponding processing of the at least one protocol layer of the terminal device.

In addition, the first signalling may further indicate or activate a TCI state for the target cell, and provide the terminal device with information about a beam that works in the target cell.

In some embodiments, the method further includes step 605: the network device transmits second configuration information to the terminal device, to update corresponding processing of at least one protocol layer of the terminal device when a second candidate cell is used as the target cell.

It may be understood that, an embodiment of this application provides a cell handover method, which mainly includes:
1. First indication information is included in first signalling, to indicate corresponding processing of one or more protocol layers in RLC re-establishment, a data recovery procedure, MAC resetting, and MAC partial resetting of a terminal device;
2. Candidate cells used for layer 1 or layer 2 handover are grouped, and the terminal device determines, based on a group to which a target cell belongs and a group to which a source cell belongs, corresponding processing of one or more protocol layers in RLC re-establishment, data recovery, MAC resetting, and MAC partial resetting of the terminal device;
3. After the terminal device is handed over to the target cell, a network device updates configuration information for each candidate cell, to update corresponding processing of one or more protocol layers in RLC re-establishment, data recovery, a MAC resetting procedure, and MAC partial resetting of the terminal device when a candidate cell is used as the target cell; and
4. In a continuous handover process, default corresponding processing of a protocol layer of the terminal device is configured according to pre-defined information.

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application. For another example, without conflicts, embodiments described in this application and/or the technical features in embodiments may be randomly combined with the prior art, and the technical solutions obtained after the combination also fall within the protection scope of this application.

It should be further understood that, in the method embodiments of this application, sequence numbers of the foregoing processes do not mean execution sequences. The execution sequences of the processes shall be determined based on functions and internal logic of the processes, and shall not be construed as any limitation on the implementation processes of embodiments of this application. In addition, in embodiments of this application, the terms “downlink”, “uplink”, and “sidelink” are used to indicate a transmission direction of a signal or data, where “downlink” indicates that a transmission direction of a signal or data is a first direction from a station to a user equipment in a cell, “uplink” indicates that a transmission direction of a signal or data is a second direction from a user equipment in a cell to a station, and “sidelink” indicates that a transmission direction of a signal or data is a third direction from a user equipment 1 to a user equipment 2. For example, “downlink signal” indicates that a transmission direction of a signal is a first direction. In addition, in embodiments of this application, the term “and/or” is merely used to describe an association between associated objects, and represents that there may be three relationships. Specifically, A and/or B may represent three cases: only A exists, both A and B exist, and only B exists. In addition, the character “/” herein generally indicates an “or” relationship between the associated objects.

An embodiment of this application further provides a cell handover apparatus, applied to a terminal device. FIG. 12 is a schematic structural diagram 1 of a cell handover apparatus according to an embodiment of this application. As shown in FIG. 12, the cell handover apparatus 120 includes:
a first communications unit 1201, configured to receive first signalling transmitted by a network device, where the first signalling is used to indicate that a first candidate cell in at least one candidate cell is used as a target cell to which the terminal device is to be handed over, and the at least one candidate cell is used for layer 1 or layer 2 handover; and
a first processing unit 1202, configured to hand over to the target cell based on the first signalling, and determine corresponding processing of at least one protocol layer of a terminal device in a process of handing over to the target cell.

In some embodiments, the first signalling includes first indication information, and the first indication information is used to indicate the corresponding processing of the at least one protocol layer.

In some embodiments, the first indication information includes a first indication field, and the first indication field is used to indicate the corresponding processing of the at least one protocol layer.

In some embodiments, the first indication field includes at least two indication bits, and the at least two indication bits are used to indicate the corresponding processing of the at least one protocol layer. Each indication bit is used to indicate one or more operations in the corresponding processing of the at least one protocol layer; or the at least two indication bits form an entity, which is used to indicate the corresponding processing of the at least one protocol layer of the terminal device.

In some embodiments, the first signalling includes second indication information, and the second indication information is used to indicate that the first candidate cell in the at least one candidate cell is used as the target cell to which the terminal device is to be handed over. Exemplarily, the first signalling includes the first indication information and the second indication information, the first indication information is used to indicate the corresponding processing of the at least one protocol layer, and the second indication information is used to indicate the target cell. Alternatively, the first signalling includes the second indication information, the second indication information is used to indicate the target cell, and the corresponding processing of the at least one protocol layer may be pre-defined in a protocol.

In some embodiments, the first signalling includes first indication information, and the first indication information includes an index of a candidate cell group to which the first candidate cell belongs and/or an index of the first candidate cell. The at least one candidate cell is grouped into at least one candidate cell group, and each candidate cell group includes at least one candidate cell. The first processing unit 1202 is configured to determine, based on a candidate cell group to which the target cell belongs and a candidate cell group to which a source cell belongs, the corresponding processing of the at least one protocol layer of the terminal device in the process of handing over to the target cell.

In some embodiments, the first processing unit 1202 is configured to: if the target cell and the source cell do not belong to a same candidate cell group, determine to execute the corresponding processing of the at least one protocol layer; or if the target cell and the source cell belong to a same candidate cell group, determine not to execute the corresponding processing of the at least one protocol layer. Exemplarily, the corresponding processing of the at least one protocol layer includes RLC re-establishment, PDCP data recovery, and MAC resetting.

In some embodiments, the first signalling is carried by a medium access control control element and/or downlink control information. In some embodiments, the first communications unit 1201 is configured to: before receiving the first signalling transmitted by the network device, receive first configuration information transmitted by the network device, where the first configuration information includes configuration information of the at least one candidate cell. In some embodiments, the first configuration information further includes configuration information of at least one candidate cell group, and configuration information of each candidate cell group includes configuration information of at least one candidate cell.

In some embodiments, the first processing unit 1202 is configured to: when the first n times of cell handover is executed based on the first configuration information, hand over to the target cell based on the first signalling, and determine the corresponding processing of the at least one protocol layer of the terminal device in the process of handing over to the target cell.

In some embodiments, the first processing unit 1202 is configured to: when cell handover after the n^{th} time of handover is executed based on the first configuration information, hand over to the target cell based on the first signalling, and determine, based on pre-defined information, the corresponding processing of the at least one protocol layer of the terminal device in the process of handing over to the target cell.

In some embodiments, the first processing unit 1202 is configured to determine, based on pre-defined information, the corresponding processing of the at least one protocol layer that is to be executed by the terminal device in the process of handing over to the target cell. The pre-defined information may be corresponding processing of at least one protocol layer that is to be executed by the terminal device by default during execution of cell handover and that is pre-defined in a protocol. For example, RLC re-establishment, PDCP data recovery, and MAC resetting are to be executed by default.

In some embodiments, the processing corresponding to the at least one protocol layer includes RLC re-establishment, PDCP data recovery, MAC resetting, MAC partial resetting, and MAC no resetting.

In some other embodiments, the first communications unit 1201 is configured to receive first configuration information transmitted by the network device, where the first configuration information includes configuration information of the at least one candidate cell, and the configuration information of the candidate cell includes corresponding processing of at least one protocol layer of the terminal device when the candidate cell is used as a target cell;
the first communications unit 1201 is configured to receive first signalling transmitted by the network device, where the first signalling is used to indicate that the first candidate cell in the at least one candidate cell is used as the target cell to which the terminal device is to be handed over, and the at least one candidate cell is used for layer 1 or layer 2 handover; and
the first processing unit 1202 is configured to hand over to the target cell based on the first signalling, and execute corresponding processing of at least one protocol layer of the terminal device when the first candidate cell is used as the target cell.

In some embodiments, the first communications unit 1201 is configured to: after handing over to the target cell based on the first signalling, receive second configuration information transmitted by the network device, where the second configuration information includes corresponding processing of at least one protocol layer of the terminal device when at least one second candidate cell is used as the target cell, and the second candidate cell is a candidate cell in the at least one candidate cell; and
the first processing unit 1202 is configured to update, based on the second configuration information, the corresponding processing of the at least protocol layer of the terminal device when the second candidate cell is used as the target cell.

In some embodiments, the second configuration information is used to indicate the at least one second candidate cell, and the at least one second candidate cell corresponds to the corresponding processing of the at least one protocol layer. In some embodiments, the second configuration information includes a cell list, and the cell list includes identity information of the at least one second candidate cell. Alternatively, the second configuration information includes a bitmap, and the bitmap is used to indicate the at least one second candidate cell.

In some embodiments, the first configuration information is carried by an RRC message, and the second configuration information is carried by an RRC message or a MAC CE.

In some embodiments, when the second configuration information is carried by a MAC CE, the first processing unit 1202 is configured to: receive the second configuration information by using a MAC layer, transmit the second configuration information to an RRC layer by using the MAC layer, and update, by using the RRC layer and based on the second configuration information, the corresponding processing of the protocol layer that is to be executed by the terminal device when the first candidate cell is used as the target cell and that is in the first configuration information; or store the second configuration information by using the MAC layer.

In some embodiments, the first signalling is layer 1 signalling and/or layer 2 signalling. Exemplarily, the first signalling includes first indication information, and the first indication information is used to indicate that the first candidate cell is used as the target cell. In some embodiments, the first signalling is carried by a medium access control control element and/or downlink control information.

In some embodiments, the corresponding processing of the at least one protocol layer includes at least one of the following: RLC re-establishment, PDCP data recovery, MAC resetting, MAC partial resetting, or MAC no resetting.

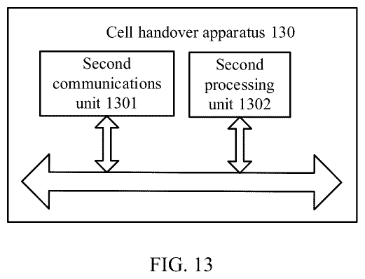

FIG. 13 is a schematic structural diagram 2 of a cell handover apparatus according to an embodiment of this application. The cell handover apparatus is applied to a network device. As shown in FIG. 13, the cell handover apparatus 130 includes:
a second communications unit 1301, configured to transmit first signalling to a terminal device, so that the terminal device is handed over to a target cell based on the first signalling, and determine corresponding processing of at least one protocol layer of the terminal device in a process of handing over to the target cell,
where the first signalling is used to indicate that a first candidate cell in at least one candidate cell is used as the target cell to which the terminal device is to be handed over, and the at least one candidate cell is used for layer 1 or layer 2 handover.

In some embodiments, the first signalling includes first indication information, and the first indication information is used to indicate the corresponding processing of the at least one protocol layer.

In some embodiments, the first indication information includes a first indication field, and the first indication field is used to indicate the corresponding processing of the at least one protocol layer.

In some embodiments, the first indication field includes at least two indication bits, and the at least two indication bits are used to indicate the corresponding processing of the at least one protocol layer. Each indication bit is used to indicate one or more operations in the corresponding processing of the at least one protocol layer; or the at least two indication bits form an entity, which is used to indicate the corresponding processing of the at least one protocol layer of the terminal device.

In some embodiments, the first signalling includes second indication information, and the second indication information is used to indicate that the first candidate cell in the at least one candidate cell is used as the target cell to which the terminal device is to be handed over. Exemplarily, the first signalling includes the first indication information and the second indication information, the first indication information is used to indicate the corresponding processing of the at least one protocol layer, and the second indication information is used to indicate the target cell. Alternatively, the first signalling includes the second indication information, the second indication information is used to indicate the target cell, and the corresponding processing of the at least one protocol layer may be pre-defined in a protocol.

In some embodiments, the first signalling includes first indication information, and the first indication information includes an index of a candidate cell group to which the first candidate cell belongs and/or an index of the first candidate cell. The at least one candidate cell is grouped into at least one candidate cell group, and each candidate cell group includes at least one candidate cell. The cell handover apparatus further includes a second processing unit 1302, configured to determine, based on a candidate cell group to which the target cell belongs and a candidate cell group to which a source cell belongs, the corresponding processing of the at least one protocol layer of the terminal device in the process of handing over to the target cell.

In some embodiments, the second processing unit 1302 is configured to: if the target cell and the source cell do not belong to a same candidate cell group, determine to execute the corresponding processing of the at least one protocol layer; or if the target cell and the source cell belong to a same candidate cell group, determine not to execute the corresponding processing of the at least one protocol layer.

In some embodiments, the corresponding processing of the at least one protocol layer includes RLC re-establishment, PDCP data recovery, and MAC resetting.

In some embodiments, the first signalling is carried by a medium access control control element and/or downlink control information.

In some embodiments, the second communications unit 1301 is configured to: before transmitting the first signalling to the terminal device, transmit first configuration information to the terminal device, where the first configuration information includes configuration information of the at least one candidate cell.

In some embodiments, the first configuration information further includes configuration information of the at least one candidate cell group, and configuration information of each candidate cell group includes configuration information of at least one candidate cell.

In some embodiments, the processing corresponding to the at least one protocol layer includes RLC re-establishment, PDCP data recovery, MAC resetting, MAC partial resetting, and MAC no resetting.

In some other embodiments, the second communications unit 1301 is configured to transmit first configuration information to the terminal device, where the first configuration information includes configuration information of the at least one candidate cell, and the configuration information of the candidate cell includes corresponding processing of at least one protocol layer of the terminal device when the candidate cell is used as a target cell; and
the second communications unit 1301 is configured to transmit first signalling to the terminal device, where the first signalling is used to indicate that the first candidate cell in the at least one candidate cell is used as the target cell to which the terminal device is to be handed over, and the at least one candidate cell is used for layer 1 or layer 2 handover.

In some embodiments, after the terminal device is handed over to the target cell based on the first signalling, the second communications unit 1301 is configured to: transmit second configuration information to the terminal device, where the second configuration information includes corresponding processing of at least one protocol layer of the terminal device when at least one second candidate cell is used as the target cell, and the second candidate cell is a candidate cell in the at least one candidate cell; and the second configuration information is used to update the corresponding processing of the at least one protocol layer of the terminal device when the second candidate cell is used as the target cell.

In some embodiments, the second configuration information is used to indicate the at least one second candidate cell, and the at least one second candidate cell corresponds to the corresponding processing of the at least one protocol layer.

In some embodiments, the second configuration information includes a cell list, and the cell list includes identity information of the at least one second candidate cell. Alternatively, the second configuration information includes a bitmap, and the bitmap is used to indicate the at least one second candidate cell.

In some embodiments, the first configuration information is carried by an RRC message, and the second configuration information is carried by an RRC message or a MAC CE.

In some embodiments, when the second configuration information is carried by a MAC CE, the terminal device receives the second configuration information by using a MAC layer, transmits the second configuration information to an RRC layer by using the MAC layer, and updates, by using the RRC layer and based on the second configuration information, corresponding processing of at least one protocol layer that is to be executed by the terminal device when the first candidate cell is used as the target cell in the first configuration information; or the terminal device stores the second configuration information by using the MAC layer.

In some embodiments, the first signalling is layer 1 signalling and/or layer 2 signalling. Exemplarily, the first signalling includes first indication information, and the first indication information is a medium access control control element and/or downlink control information.

In some embodiments, the corresponding processing of the at least one protocol layer includes at least one of the following: RLC re-establishment, PDCP data recovery, MAC resetting, MAC partial resetting, or MAC no resetting.

A person skilled in the art should understand that related descriptions of the foregoing cell handover apparatuses in embodiments of this application may be understood with reference to related descriptions of the cell handover methods in embodiments of this application.

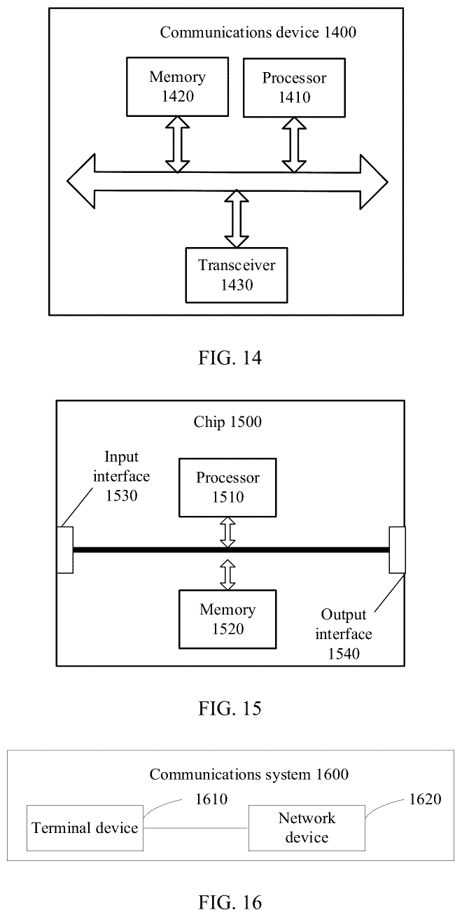

FIG. 14 is a schematic structural diagram of a communications device according to an embodiment of this application. The communications device may be a terminal device, or may be a network device. The communications device 1400 shown in FIG. 14 includes a processor 1410, and the processor 1410 may invoke a computer program from a memory and run the computer program to implement the method in embodiments of this application.

Optionally, as shown in FIG. 14, the communications device 1400 may further include a memory 1420. The processor 1410 may invoke a computer program from the memory 1420 and run the computer program to implement the method in embodiments of this application.

The memory 1420 may be a separate component independent of the processor 1410, or may be integrated into the processor 1410.

In some embodiments, as shown in FIG. 14, the communications device 1400 may further include a transceiver 1430. The processor 1410 may control the transceiver 1430 to communicate with another device, and specifically, may transmit information or data to the another device, or receive information or data transmitted by the another device.

The transceiver 1430 may include a transmitter and a receiver. The transceiver 1430 may further include an antenna, and a quantity of antennas may be one or more.

Optionally, the communications device 1400 may be a network device in embodiments of this application, and the communications device 1400 may implement corresponding procedures implemented by the network device in the methods according to embodiments of this application. For brevity, details are not described herein again.

Optionally, the communications device 1400 may be specifically a mobile terminal or a terminal device in embodiments of this application, and the communications device 1400 may implement corresponding procedures implemented by the mobile terminal or the terminal device in the methods according to embodiments of this application. For brevity, details are not described herein again.

FIG. 15 is a schematic structural diagram of a chip according to an embodiment of this application. The chip 1500 shown in FIG. 15 includes a processor 1510, and the processor 1510 may invoke a computer program from a memory and run the computer program to implement the method in embodiments of this application.

Optionally, as shown in FIG. 15, the chip 1500 may further include a memory 1520. The processor 1510 may invoke a computer program from the memory 1520 and run the computer program to implement the method in embodiments of this application.

The memory 1520 may be a separate component independent of the processor 1510, or may be integrated into the processor 1510.

Optionally, the chip 1500 may further include an input interface 1530. The processor 1510 may control the input interface 1530 to communicate with another device or chip, and specifically, may obtain information or data transmitted by the another device or chip.

Optionally, the chip 1500 may further include an output interface 1540. The processor 1510 may control the output interface 1540 to communicate with another device or chip, and specifically, may output information or data to the another device or chip.

Optionally, the chip may be applied to a network device in embodiments of this application, and the chip may implement corresponding procedures implemented by the network device in the methods according to embodiments of this application. For brevity, details are not described herein again.

Optionally, the chip may be applied to a mobile terminal or a terminal device in embodiments of this application, and the chip may implement corresponding procedures implemented by the mobile terminal or the terminal device in the methods according to embodiments of this application. For brevity, details are not described herein again.

It should be understood that the chip mentioned in this embodiment of this application may also be referred to as a system-level chip, a system chip, a chip system, a system-on-chip, or the like.

FIG. 16 is a schematic block diagram of a communications system according to an embodiment of this application. As shown in FIG. 16, the communications system 1600 includes a terminal device 1610 and a network device 1620.

The terminal device 1610 may be configured to implement corresponding functions implemented by a terminal device in the foregoing methods, and the network device 1620 may be configured to implement corresponding functions implemented by a network device in the foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to a network device in embodiments of this application, and the computer program causes a computer to execute corresponding procedures implemented by the network device in the methods according to embodiments of this application. For brevity, details are not described herein again.

Optionally, the computer-readable storage medium may be applied to a mobile terminal or a terminal device in embodiments of this application, and the computer program causes a computer to execute corresponding procedures implemented by the mobile terminal or the terminal device in the methods according to embodiments of this application. For brevity, details are not described herein again.

An embodiment of this application further provides a computer program product, which includes computer program instructions.

Optionally, the computer program product may be applied to a network device in embodiments of this application, and the computer program instructions cause a computer to execute a corresponding procedure implemented by the network device in the methods according to embodiments of this application. For brevity, details are not described herein again.

Optionally, the computer program product may be applied to a mobile terminal/terminal device in embodiments of this application, and the computer program instructions cause a computer to execute a corresponding procedure implemented by the mobile terminal/terminal device in the methods according to embodiments of this application. For brevity, details are not described herein again.

An embodiment of this application further provides a computer program.

Optionally, the computer program may be applied to a network device in embodiments of this application. When the computer program runs on a computer, the computer executes a corresponding procedure implemented by the network device in the methods according to embodiments of this application. For brevity, details are not described herein again.

Optionally, the computer program may be applied to a mobile terminal/terminal device in embodiments of this application. When the computer program runs on a computer, the computer executes a corresponding procedure implemented by the mobile terminal/terminal device in the methods according to embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

Those skilled in the art may clearly understand that, for the purpose of convenient and brief description, for detailed working processes of the foregoing system, apparatus, and unit, reference may be made to the corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in the form of a software product. The computer software product is stored in a storage medium and includes several instructions for instructing a computer device (which may be a personal computer, a server, a network device, or the like) to execute all or some of the steps of the methods described in embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A terminal device, wherein the terminal device comprises a processor and a memory, wherein the memory is configured to store a computer program, and the processor is configured to execute the computer program to cause the terminal device to perform a method including:
receiving first signalling transmitted by a network device, wherein the first signalling is used to indicate that a first candidate cell in at least one candidate cell is used as a target cell to which the terminal device is to be handed over, and the at least one candidate cell is used for layer 1 or layer 2 handover; and
handing over to the target cell based on the first signalling, and determining corresponding processing of at least one protocol layer of the terminal device in a process of handing over to the target cell.

2. The terminal device according to claim 1, wherein the first signalling comprises first indication information, and the first indication information is used to indicate the corresponding processing of the at least one protocol layer;
wherein the first indication information comprises a first indication field, and the first indication field is used to indicate the corresponding processing of the at least one protocol layer.

3. The terminal device according to claim 1, wherein the first signalling comprises second indication information, and the second indication information is used to indicate that the first candidate cell is used as the target cell.

4. The terminal device according to claim 1, wherein the first signalling comprises first indication information, and the first indication information comprises an index of a candidate cell group to which the first candidate cell belongs and/or an index of the first candidate cell.

5. The terminal device according to claim 4, wherein the at least one candidate cell is grouped into at least one candidate cell group, and each candidate cell group comprises at least one candidate cell; and
wherein the determining corresponding processing of at least one protocol layer of the terminal device in a process of handing over to the target cell comprises:
determining, based on a candidate cell group to which the target cell belongs and a candidate cell group to which a source cell belongs, the corresponding processing of the at least one protocol layer of the terminal device in the process of handing over to the target cell;
wherein the determining, based on a candidate cell group to which the target cell belongs and a candidate cell group to which a source cell belongs, the corresponding processing of the at least one protocol layer of the terminal device in the process of handing over to the target cell comprises:
if the target cell and the source cell do not belong to a same candidate cell group, determining to execute the corresponding processing of the at least one protocol layer; or
if the target cell and the source cell belong to a same candidate cell group, determining not to execute the corresponding processing of the at least one protocol layer.

6. The terminal device according to claim 1, wherein before the receiving first signalling transmitted by a network device, the terminal device is further configured to:
receive first configuration information transmitted by the network device, wherein the first configuration information comprises configuration information of the at least one candidate cell.

7. The terminal device according to claim 6, wherein the first configuration information further comprises configuration information of at least one candidate cell group, and configuration information of each candidate cell group comprises configuration information of the at least one candidate cell.

8. The terminal device according to claim 1, wherein the first signalling is carried by a medium access control control element and/or downlink control information;
wherein the processing corresponding to the at least one protocol layer comprises RLC re-establishment, PDCP data recovery, MAC resetting, MAC partial resetting, and MAC no resetting.

9. A network device, wherein the network device comprises a processor and a memory, wherein the memory is configured to store a computer program, and the processor is configured to execute the computer program to cause the network device to perform a method including:
transmitting first signalling to a terminal device to instruct the terminal device to hand over to a target cell based on the first signalling, and determining corresponding processing of at least one protocol layer of the terminal device in a process of handing over to the target cell,
wherein the first signalling is used to indicate that a first candidate cell in at least one candidate cell is used as the target cell to which the terminal device is to be handed over, and the at least one candidate cell is used for layer 1 or layer 2 handover.

10. The network device according to claim 9, wherein the first signalling comprises first indication information, and the first indication information is used to indicate the corresponding processing of the at least one protocol layer;
wherein the first indication information comprises a first indication field, and the first indication field is used to indicate the corresponding processing of the at least one protocol layer.

11. The network device according to claim 9, wherein the first signalling comprises second indication information, and the second indication information is used to indicate that the first candidate cell is used as the target cell.

12. The network device according to claim 9, wherein the first signalling comprises first indication information, and the first indication information comprises an index of a candidate cell group to which the first candidate cell belongs and/or an index of the first candidate cell.

13. The network device according to claim 12, wherein the at least one candidate cell is grouped into at least one candidate cell group, and each candidate cell group comprises at least one candidate cell; and
wherein the network device is further configured to: determine, based on a candidate cell group to which the target cell belongs and a candidate cell group to which a source cell belongs, the corresponding processing of the at least one protocol layer of the terminal device in the process of handing over to the target cell;
wherein the determining, based on a candidate cell group to which the target cell belongs and a candidate cell group to which a source cell belongs, the corresponding processing of the at least one protocol layer of the terminal device in the process of handing over to the target cell comprises:
if the target cell and the source cell do not belong to a same candidate cell group, determining to execute the corresponding processing of the at least one protocol layer; or
if the target cell and the source cell belong to a same candidate cell group, determining not to execute the corresponding processing of the at least one protocol layer.

14. The network device according to claim 9, wherein before the transmitting first signalling to a terminal device, the network device is further configured to:
transmit first configuration information to the terminal device, wherein the first configuration information comprises configuration information of the at least one candidate cell.

15. The network device according to claim 14, wherein the first configuration information further comprises configuration information of at least one candidate cell group, and configuration information of each candidate cell group comprises configuration information of the at least one candidate cell.

16. The network device according to claim 9, wherein the first signalling is carried by a medium access control control element and/or downlink control information;
wherein the processing corresponding to the at least one protocol layer comprises RLC re-establishment, PDCP data recovery, MAC resetting, MAC partial resetting, and MAC no resetting.

17. A cell handover method, applied to a terminal device, wherein the method comprises:
receiving first signalling transmitted by a network device, wherein the first signalling is used to indicate that a first candidate cell in at least one candidate cell is used as a target cell to which the terminal device is to be handed over, and the at least one candidate cell is used for layer 1 or layer 2 handover; and
handing over to the target cell based on the first signalling, and determining corresponding processing of at least one protocol layer of the terminal device in a process of handing over to the target cell.

18. The method according to claim 17, wherein the first signalling comprises first indication information, and the first indication information is used to indicate the corresponding processing of the at least one protocol layer;
wherein the first indication information comprises a first indication field, and the first indication field is used to indicate the corresponding processing of the at least one protocol layer.

19. The method according to claim 17, wherein the first signalling comprises second indication information, and the second indication information is used to indicate that the first candidate cell is used as the target cell.

20. The method according to claim 17, wherein the first signalling comprises first indication information, and the first indication information comprises an index of a candidate cell group to which the first candidate cell belongs and/or an index of the first candidate cell.
